(19) United States
(12) Patent Application Publication
(10) Pub. No.: US 2026/0278392 A1
(43) Pub. Date: Sep. 17, 2026

(54) SYSTEM

(71) Applicant: SoftBank Group Corp., Tokyo (JP)

(72) Inventor: Masanao KOJIMA, Tokyo (JP)

(73) Assignee: SoftBank Group Corp., Tokyo (JP)

(21) Appl. No.: 19/547,721

(22) Filed: Feb. 24, 2026

Related U.S. Application Data
(60) Provisional application No. 63/769,915, filed on Mar. 11, 2025.

(51) Int. Cl. G06N 3/094; G06N 3/044; G06N 3/0464; G06N 3/0475

(52) U.S. Cl. CPC G06N 3/094; G06N 3/044; G06N 3/0464; G06N 3/0475

(57) ABSTRACT

A system includes a processor, wherein the processor is configured to control a sensor unit configured to acquire brain wave data from a plurality of electrodes worn on a scalp of a subject and to acquire the brain wave data in real time, analyze brain wave data of the subject by using a brain wave database collected from healthy persons and persons with disabilities, and execute a machine learning algorithm configured to identify an intended action of the subject based on the brain wave data, and control a robot unit including an exoskeleton device or a robotic arm worn on a body of the subject so as to assist a body movement of the subject based on an analysis result of the machine learning algorithm.

### CROSS-REFERENCE TO RELATED APPLICATION

This application claims the benefit of U.S. Provisional Application No. 63/769,915, filed on Mar. 11, 2025, pursuant to 35 U.S.C. § 119 (e), the entire contents of which are incorporated herein by reference.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional assistive devices for persons with physical disabilities, such as exoskeletons and robotic arms, generally rely on manual input devices including switches, joysticks, or voice commands. These interfaces require residual motor skills, cognitive load to operate the interface itself, or a quiet acoustic environment, and therefore are not suitable for users with severe motor impairments or in noisy conditions. Furthermore, traditional systems do not directly interpret the user's internal intention from brain activity, resulting in delayed, indirect, or unnatural control of body movements. Existing brain-computer interface techniques that attempt to use EEG signals often suffer from low accuracy, limited robustness across different users and conditions, and poor real-time performance, especially when used to control complex body motions via robotic devices. Accordingly, there is a need for a system that can acquire brain wave data of a subject in real time, accurately identify an intended action of the subject by using advanced machine learning based on a rich brain wave database, and directly assist body movements through an exoskeleton device or robotic arm in a natural and responsive manner, thereby improving independence and quality of life for persons with physical disabilities.

### SUMMARY

In order to solve the above problems, the present invention provides a system comprising a processor, wherein the processor is configured to control a sensor unit to acquire brain wave data from a plurality of electrodes worn on a scalp of a subject in real time, and to analyze the acquired brain wave data of the subject by using a brain wave database collected from healthy persons and persons with disabilities. The processor is further configured to execute a machine learning algorithm, including a neural network using deep learning, such as a convolutional neural network and a recurrent neural network, to collate the brain wave data of the subject with the brain wave database and to identify an intended action of the subject. In addition, the processor is configured to control a robot unit including an exoskeleton device or a robotic arm worn on a body of the subject so as to assist a body movement of the subject based on an analysis result of the machine learning algorithm. The processor controls the robot unit to sense a movement and a force of the body of the subject, to perform feedback control to realize a natural motion, and to enable the subject to move the body based on an internal intention without requiring conventional manual input devices, thereby providing a real-time, intention-driven assistive system for body movement support.

The term “system” refers to an integrated arrangement of hardware and software components including at least a processor, a sensor unit, and a robot unit, configured to perform the processing and control operations as claimed.

The term “processor” refers to one or more hardware processing units, such as a microprocessor, microcontroller, digital signal processor, or other computing circuitry, capable of executing instructions to control the sensor unit, analyze brain wave data, execute machine learning algorithms, and control the robot unit.

The term “sensor unit” refers to a component or assembly that includes one or more sensors, including a plurality of electrodes configured to be worn on a scalp of a subject, and associated circuitry or interfaces for acquiring brain wave data in real time.

The term “brain wave data” refers to electrical signals representing brain activity of the subject, typically measured as electroencephalogram (EEG) signals via electrodes placed on the scalp, and including digitized values over time for a plurality of channels.

The term “electrode” refers to a conductive element or sensor interface that is configured to be placed in contact with, or in proximity to, the scalp of the subject in order to detect electrical potentials associated with brain activity and output corresponding electrical signals.

The term “subject” refers to a human user, including a person with or without physical disabilities, whose brain wave data is acquired by the sensor unit and whose body movement is assisted by the robot unit.

The term “real time” refers to processing and control operations that are performed with sufficiently low delay such that the system can respond to changes in the subject's brain wave data and intended actions in a manner perceived as immediate or continuous by the subject.

The term “brain wave database” refers to a collection of stored brain wave data records acquired from multiple individuals, including healthy persons and persons with disabilities, optionally annotated with labels indicating associated actions or intentions, and used for training or reference in machine learning algorithms.

The term “machine learning algorithm” refers to a computational method or model that learns patterns or relationships from data, including but not limited to neural networks, and that is configured to process brain wave data to identify an intended action of the subject.

The term “neural network using deep learning” refers to a multi-layered computational model comprising multiple interconnected nodes or units arranged in layers, trained by a deep learning procedure (such as gradient-based optimization) to map input brain wave data to outputs representing predicted actions or intentions.

The term “convolutional neural network” refers to a type of neural network that includes one or more convolutional layers configured to apply learnable filters over spatial, temporal, or spatiotemporal dimensions of the brain wave data in order to extract features useful for classifying or identifying the subject's intended action.

The term “recurrent neural network” refers to a type of neural network that includes recurrent connections or memory mechanisms, such as LSTM or GRU units, configured to process sequences of brain wave data over time and to capture temporal dependencies related to the subject's intended action.

The term “intended action” refers to an internal intention or mental command of the subject regarding a desired body movement or operation, such as starting or stopping walking or lifting an object, which is inferred by analyzing brain wave data.

The term “robot unit” refers to a component or assembly including an exoskeleton device, a robotic arm, or both, together with actuators, sensors, and control interfaces, configured to assist or perform body movements of the subject under control of the processor.

The term “exoskeleton device” refers to a wearable robotic structure that is attached to or worn on at least a part of the subject's body, such as the lower limbs or upper limbs, and that includes joints, actuators, and sensors for assisting or augmenting the subject's body movements.

The term “robotic arm” refers to a robotic manipulator having one or more articulated segments and joints, configured to be mounted on or worn by the subject or placed in proximity to the subject, and capable of performing movements such as reaching, grasping, and lifting under control of the processor.

The term “body movement” refers to a physical motion or change of posture of at least a portion of the subject's body, including movements such as walking, standing up, sitting down, raising an arm, or lifting an object, which is assisted by the robot unit.

The term “analysis result” refers to output data generated by the machine learning algorithm or other processing executed by the processor, including at least an identified intended action of the subject and optionally associated control parameters, which is used to control the robot unit.

The term “feedback control” refers to a control method in which the robot unit measures one or more physical quantities, such as position, velocity, or force of the subject's body or of the robot actuators, and adjusts control commands based on the measured values to achieve stable, natural, or desired motion.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

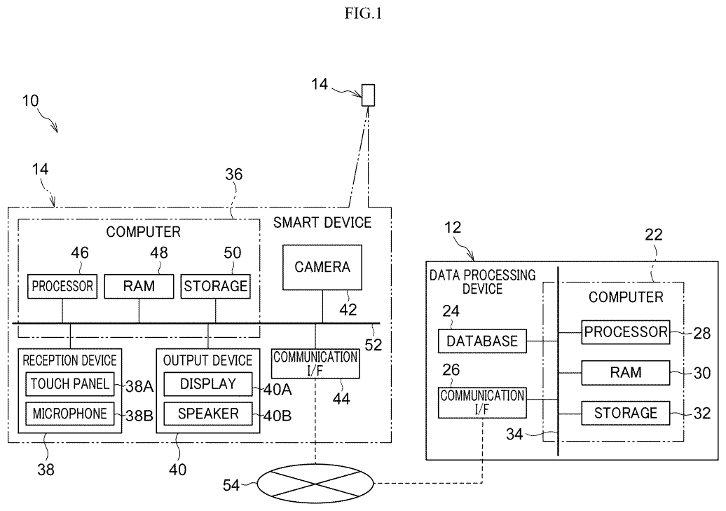

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

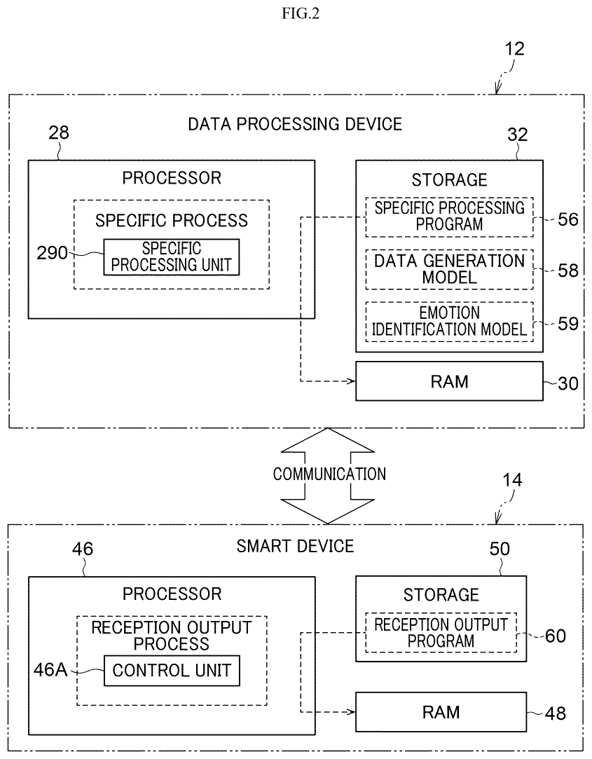

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional brain-computer interface systems that assist body motion typically adopt monolithic architectures in which signal acquisition, preprocessing, model inference, and actuator control are tightly coupled and manually engineered. Such systems suffer from several technical limitations. First, they often rely on fixed, heuristic signal-processing pipelines and static classifier models that are not adapted to individual users or long-term changes in brain signals, resulting in reduced classification accuracy and unstable control behavior over time. Second, the mapping from high-level user intention to low-level actuator commands is frequently implemented as ad hoc logic in firmware or application software, which impedes systematic tuning of feedback control loops and degrades responsiveness, smoothness, and safety of multi-joint robotic mechanisms. Third, existing architectures generally lack an integrated mechanism to use rich runtime data-such as time-series bioelectrical signals, classification outputs, motion execution results, and user feedback-to improve the entire system in a closed loop, and to automatically redesign or refine model structures and control algorithms. This leads to significant engineering overhead whenever system performance must be improved or new action classes are introduced.

Furthermore, many known systems do not effectively combine cloud-side numerical computation resources and local terminal processing in a coordinated way. As a result, heavy numerical tasks, such as tensor conversion of time-series data and deep neural inference, are either constrained by the limited resources of a portable terminal or are performed on a server without proper real-time coordination with the terminal and robot mechanism. This imbalance can cause excessive latency, jitter, and loss of synchronization between intention recognition and actuator control, which directly impacts the technical quality of motion assistance.

Additionally, current approaches seldom exploit generative AI technology as an integral system component. In particular, there is no unified framework in which a generative AI model is driven by explicit prompt sentences describing signal-processing configurations, model structures, command formats, and feedback control rules, such that the model can automatically generate or refine both the trained intention-classification model and the control algorithm for the multi-joint drive mechanism. Consequently, the process of model and controller design remains predominantly manual and fragmented, which limits scalability and hinders continuous, data-driven optimization.

Accordingly, there is a need for a computer-implemented system that improves core computer technology related to time-series signal processing, deep neural inference, and closed-loop control by: (i) distributing preprocessing and communication functions to a terminal while centralizing high-load numerical computation and adaptive model management on a server; (ii) unifying the representation and logging of time-series data, intention information, motion commands, and execution results to enable systematic adaptive learning; and (iii) integrating a generative AI model, controlled through prompt sentences, to automatically design and refine both intention-recognition models and feedback-control algorithms. By addressing these issues, the system can provide more accurate, low-latency, and safe motion assistance, while reducing the engineering burden for maintaining and improving the underlying computer-implemented components.

The specific processing by the specific processing unit 290 of the data processing device 12 in Example 1 is realized by the following means.

The present invention provides a server comprising at least one processor and at least one memory storing instructions which, when executed by the at least one processor, cause the server to receive, from a terminal device, time-series data sets representing preprocessed digital bioelectrical signals acquired via electrodes attached to a scalp of a user; convert the time-series data sets into tensor data by numerical computation; execute inference processing using a trained information processing model that includes a convolution computation layer configured to extract spatial and frequency features and a recurrent computation layer configured to analyze temporal transitions of the features, so as to output intention information corresponding to a predetermined action of the user; generate high-level motion command data including at least a motion type, a motion target body part, and an assistance intensity based on the intention information; transmit the high-level motion command data to the terminal device for conversion into low-level control command data to drive a body-worn multi-joint drive mechanism; record, in association with one another, the time-series data sets, the intention information, the high-level motion command data, and information on an execution result of motion assistance performed by the multi-joint drive mechanism; perform adaptive learning processing to relearn and update parameters of the trained information processing model on a per-user basis using the recorded information; and execute a generative design process in which a generative AI model receives at least one prompt sentence describing a structure of the trained information processing model, signal-processing conditions, a format of the high-level motion command data, and control rules for feedback control of the multi-joint drive mechanism, and automatically generates or refines at least a part of the trained information processing model and a control algorithm for the multi-joint drive mechanism. This enables an improvement of core computer technology for time-series signal processing, deep neural inference, and closed-loop control by providing a distributed architecture that reduces latency and resource constraints, an integrated adaptive learning loop that continuously personalizes intention recognition, and a generative-AI-driven mechanism that systematically designs and optimizes both classification models and control algorithms based on explicit, machine-interpretable specifications.

The term “processor” refers to one or more hardware processing units, such as a central processing unit, a digital signal processor, a graphics processing unit, or a programmable logic device, configured to execute instructions to perform numerical computation, data processing, and control operations.

The term “memory” refers to one or more hardware storage components, such as semiconductor memory, magnetic storage, or optical storage, configured to store instructions and data for access by a processor.

The term “terminal device” refers to an electronic apparatus operated in proximity to a user and configured to communicate with a server and a robot mechanism, to receive digital bioelectrical signals, to perform local signal preprocessing, and to transmit preprocessed data and motion command data.

The term “server” refers to a computer system, which may include one or more physical or virtual machines, configured to perform centralized numerical computation, inference processing, data storage, adaptive learning, and generative design processing, and to communicate with one or more terminal devices.

The term “electrode” refers to an electrical interface element configured to contact a surface of a body of a user, such as a scalp, and to detect bioelectrical potential differences for conversion into bioelectrical signals.

The term “bioelectrical signal” refers to an analog or digital representation of an electrical activity generated by a biological organism, including but not limited to brain activity, that is detectable via one or more electrodes.

The term “digital signal” refers to a discrete-time, quantized representation of an analog bioelectrical signal obtained through sampling and analog-to-digital conversion.

The term “preprocessing” refers to a set of signal-processing operations performed on digital signals prior to inference processing, including at least filtering, normalization, and segmentation into time intervals.

The term “band-pass filter process” refers to a signal-processing operation configured to pass only frequency components within a predetermined frequency band and to attenuate frequency components outside the band.

The term “notch filter process” refers to a signal-processing operation configured to attenuate or suppress frequency components within a narrow frequency range, such as a power-supply frequency and its harmonics.

The term “time-series data” refers to data representing a sequence of values of one or more variables, such as bioelectrical signal amplitudes, indexed in temporal order at discrete time points.

The term “data set” refers to a collection of samples of time-series data corresponding to a predetermined time interval and including associated metadata such as time stamps, channel identifiers, and sampling parameters.

The term “tensor data” refers to a multi-dimensional numerical array structure used to represent time-series data and related features in a format suitable for numerical computation and machine-learning model input.

The term “information processing model” refers to a machine-implemented model, such as a deep neural network, configured to receive tensor data as input, to compute intermediate representations, and to output inference results such as classification outputs.

The term “convolution computation layer” refers to a processing component of an information processing model that performs convolution operations over input data to extract spatial or frequency features.

The term “recurrent computation layer” refers to a processing component of an information processing model that performs recurrent operations over sequences of input data to analyze temporal transitions and contextual dependencies.

The term “intention information” refers to information representing an estimated intention of a user, including at least one action category or state associated with a predetermined body motion.

The term “high-level motion command data” refers to motion instruction data that abstractly specifies a desired motion, including at least a motion type, a motion target body part, and an assistance intensity, without directly specifying individual actuator control values.

The term “low-level control command data” refers to control instruction data for a robot mechanism that specifies concrete control parameters for actuators, such as joint target positions, velocities, torques, or forces, derived from high-level motion command data.

The term “multi-joint drive mechanism” refers to a mechanical assembly including two or more joints and corresponding actuators configured to generate movement of one or more body parts of a user through controlled joint motion.

The term “sensor” refers to a hardware element configured to detect one or more physical quantities associated with a multi-joint drive mechanism, such as joint angle, angular velocity, linear acceleration, force, or torque, and to output corresponding sensor signals.

The term “joint trajectory” refers to a time-varying sequence of desired joint states, including at least joint angles and optionally velocities or accelerations, that defines a target motion of a multi-joint drive mechanism.

The term “feedback control computation” refers to a control process in which a drive output is computed based on a difference between a desired state, such as a joint trajectory, and a detected state from a sensor, in order to reduce the difference over time.

The term “body-worn” refers to a configuration in which at least part of a device, such as a multi-joint drive mechanism, is physically attached to or supported by a body of a user during operation.

The term “motion assistance” refers to a process in which a multi-joint drive mechanism applies mechanical support or force to a body of a user so as to aid, enhance, or complement voluntary body motion of the user.

The term “execution result information” refers to information indicating an outcome of a motion assistance process, including at least whether a commanded motion was started, completed, interrupted, or failed, and optionally including performance or safety indicators.

The term “adaptive learning process” refers to a process in which parameters of an information processing model are updated based on newly collected time-series data, intention information, motion command data, and execution result information, so as to improve inference performance over time.

The term “generative AI model” refers to a machine-learning model configured to generate data, such as program code, model architecture definitions, or control rules, in response to input conditions or prompt sentences.

The term “prompt sentence” refers to a machine-interpretable textual instruction or description supplied to a generative AI model, specifying at least a structure, condition, format, or rule that the generative AI model is to use as a basis for generating or modifying an output.

The term “generative design process” refers to a process in which a generative AI model receives at least one prompt sentence describing one or more aspects of a system, such as an information processing model structure, signal-processing conditions, motion command formats, or control rules, and automatically generates or refines at least a part of such aspects.

The term “encrypted communication path” refers to a communication channel between devices in which transmitted data is transformed by an encryption algorithm so as to protect confidentiality and integrity of the data.

The term “local communication path” refers to a communication channel between a terminal device and a robot mechanism implemented over a short-range or direct connection, such as a wired link or a short-range wireless link.

In one embodiment, a system includes a server, a terminal, a sensor unit, and a robot unit. The server, the terminal, and the robot unit are implemented on general-purpose computing hardware such as a central processing unit, a graphics processing unit, and semiconductor memory, while the sensor unit is implemented by an EEG headset with multiple electrodes and integrated analog-digital conversion circuitry. The system is configured to acquire bioelectrical signals from a user, to process the signals as time-series data using a trained neural network model on the server, and to control a body-worn multi-joint drive mechanism based on high-level motion commands derived from the neural network output.

The terminal executes an acquisition program that interfaces with the EEG headset through a device driver and an application programming interface provided by the EEG manufacturer. The terminal acquires multichannel EEG signals from the EEG headset at a predetermined sampling frequency, for example 256 samples per second per channel, and converts analog voltages into digital sample values using an analog-to-digital converter embedded in the EEG headset. The terminal stores the digital sample values in a circular buffer in a main memory of the terminal. In this way, the terminal forms contiguous segments of digital signals that represent short intervals of brain activity.

The terminal applies signal-processing software implemented using a numerical library, such as a digital filter library compiled for the terminal's operating system, to the buffered digital signals. The terminal applies a band-pass filter that passes only frequency components between, for example, 0.5 Hz and 40 Hz, and applies a notch filter that suppresses a power-supply frequency component such as 50 Hz or 60 Hz. The terminal normalizes each channel, for example by subtracting a moving average and dividing by a moving standard deviation, to align the amplitude ranges of different channels. The terminal constructs a data structure for each segment, including a time stamp, a user identifier, channel identifiers, sampling frequency, and a two-dimensional array of sample values. This data structure enables efficient tensor conversion on the server, reducing computational overhead and improving cache utilization compared to unstructured signal streams.

The terminal executes a communication program that establishes an encrypted communication channel with the server using a transport layer security protocol. The terminal transmits the structured data segments to the server as binary or text-encoded messages. By performing filtering and structuring at the terminal, the system reduces uplink bandwidth requirements and avoids transmitting redundant noise components, thereby improving communication efficiency.

The server executes a data ingestion program that receives the structured data segments from one or more terminals. The server stores the received data segments in a time-series database or an object store, with indices based on user identifiers and time stamps. The server transforms each two-dimensional array of samples into a tensor structure compatible with a deep learning framework. The server stacks multiple consecutive segments to form a three-dimensional tensor whose axes correspond to channels, time, and segment index. This specific tensor arrangement allows convolutional layers to operate along the time and channel axes while recurrent layers process sequences of feature vectors.

The server executes a trained information processing model implemented as a hybrid neural network including at least one convolutional layer and at least one recurrent layer. The server configures the convolutional layer with kernel sizes that span multiple channels and short temporal windows, for example a kernel shape of (3 channels×25 time samples), and configures a stride and padding to preserve temporal resolution while aggregating local spatial patterns across electrodes. The server applies an activation function such as a rectified linear unit after the convolutional operation to introduce non-linearity. The server further applies batch normalization to stabilize the distribution of intermediate features, which improves convergence and allows higher learning rates.

The server executes a pooling operation, such as average pooling or max pooling, along the time axis to reduce temporal resolution and to emphasize robust patterns. The server feeds the pooled feature vectors into a recurrent layer, such as a long short-term memory network or a gated recurrent unit, configured with a hidden state dimension sufficient to capture temporal dependencies across multiple seconds of EEG data. The server updates the hidden state at each time step based on the current feature vector and the previous hidden state, using learned recurrent weights and gating functions. The server then applies a fully connected output layer and a softmax function to compute probabilities for each predefined intention class.

The server selects an intention class with the highest probability as intention information, subject to a confidence threshold. The server may also compute a rejection class if all intention probabilities fall below a threshold, to avoid issuing unintended commands. The server maps the selected intention to a high-level motion command that includes at least a motion type, a target body part, and an assistance intensity. For example, when the intention corresponds to an action “start walking,” the server sets the motion type to a walking start command, the target body part to lower limbs, and the assistance intensity to a moderate value based on the confidence score.

The server executes a command generation program that constructs a high-level motion command data structure. The data structure includes, for example, an action identifier, a body-part identifier, an intensity parameter, a time stamp, and optional configuration flags such as maximum allowable torque or maximum stride length. The server transmits the high-level motion command data to the terminal using a low-latency communication protocol, such as a persistent messaging connection or a streaming protocol.

The terminal executes a control program that receives the high-level motion command data from the server. The terminal converts the abstract motion type and assistance intensity into low-level control command data that specify target joint angles, velocities, and allowable torque ranges for each actuator of the multi-joint drive mechanism. The terminal uses a mapping table or a parameterized function stored in the terminal memory to transform the high-level command into a sequence of joint-space waypoints. The terminal sends the low-level control command data to the robot unit using a local communication path, such as a wired bus or a short-range wireless link.

The robot unit implements a multi-joint drive mechanism, for example an exoskeleton or an articulated robotic arm, using actuators such as electric motors with encoders. The robot unit measures joint angles, angular velocities, and interaction forces using sensors attached to joints and structural members. The robot unit executes a feedback control algorithm at a fixed cycle, for example 1 kHz, on a local processor. The robot unit computes an error between a target joint trajectory obtained from the low-level control command and a current measured joint state, and applies a control law such as a proportional-integral-derivative control to determine the actuator command. The robot unit may also apply a model-based feedforward term to compensate for gravitational and inertial effects.

The server stores execution result information corresponding to each high-level motion command. The server correlates the original time-series data, intention information, high-level commands, and execution results in a database. For example, the server records whether the robot unit successfully followed the target trajectory within a tolerance, whether the user activated a safety stop switch, and whether any error conditions were reported. This correlated dataset forms a basis for adaptive learning and model evaluation.

The server executes a training program that performs adaptive learning of the neural network model. The server partitions the recorded dataset into training and validation sets. The server uses a loss function such as cross-entropy loss to measure a discrepancy between predicted intention probabilities and ground-truth labels derived from the execution results and user feedback. The server computes gradients of the loss function with respect to model weights using backpropagation through time for the recurrent layer and standard backpropagation for the convolutional and fully connected layers. The server updates the model weights using an optimization algorithm such as an adaptive gradient-based optimizer, with learning rate scheduling. The server may also apply data augmentation techniques, such as adding small noise perturbations or time-warping the EEG segments, to improve generalization.

The server evaluates the updated model on the validation set and compares performance metrics, such as overall accuracy, class-wise precision and recall, and false positive rate, with those of the currently deployed model. When the updated model satisfies predefined improvement criteria, the server replaces the deployed model in the inference service with the updated model. Because the model is retrained using user-specific data, the system gradually adapts to shifts in the user's brain signal patterns and motor behavior, thereby improving classification accuracy and reducing unwanted commands.

The server also executes a generative design program that cooperates with a generative AI model. The server provides the generative AI model with prompt sentences that describe desired properties of the signal processing pipeline, the neural network architecture, and the control algorithms. For example, the server may provide the following prompt sentence:

“Design a convolutional-recurrent neural network that receives eight-channel EEG time-series data, uses 0.5-40 Hz band-pass filtering and 50 Hz notch filtering, extracts spatial-temporal features with convolutional kernels of size 3 by 25, models temporal dependencies with a recurrent layer having 64 hidden units, and outputs intention classes ‘start walking’, ‘stop walking’, ‘lift object’, and ‘move hand’ with high accuracy and low latency.”

In another example, the server may provide a prompt sentence:

“Generate a motion-control algorithm for a lower-limb exoskeleton that accepts high-level commands ‘start walking’ and ‘stop walking’, computes joint trajectories for hip and knee joints, and applies feedback control using encoder and inertial sensor readings to ensure stable gait and limit peak torque.”

The server receives from the generative AI model textual descriptions of proposed network architectures, hyperparameters, and control rules generated in response to these prompt sentences. The server parses the textual descriptions and converts them into configuration files or parameter sets that can be loaded into the training and control programs. By using the generative AI model in this structured way, the server is not merely automating human design work, but rather reconfiguring core computational components—such as layer structures, kernel sizes, and control gains—based on machine-generated designs that are evaluated numerically and iteratively improved.

The server thereby improves computer technology in several respects. The distribution of band-limited, structured time-series data from the terminal to the server reduces network traffic and reduces server-side preprocessing time, resulting in lower end-to-end latency. The tensor arrangement optimized for convolution and recurrent operations improves cache coherence and reduces memory access overhead during neural inference, thereby increasing throughput on the server's processor. The integrated logging and adaptive learning workflow enables on-the-fly personalization of the model, without manual reconfiguration or static retraining, which is not achievable through simple human monitoring. The generative design process expands the space of candidate models and controllers beyond what a human engineer could feasibly enumerate, and the server validates each candidate based on quantitative performance metrics, thereby driving systematic improvement of the computational pipeline.

The terminal, the server, and the robot unit interact in a way that directly controls a physical multi-joint drive mechanism in real time. This connection to physical actuators distinguishes the disclosed system from abstract data processing. The intention information produced by the neural network is converted into concrete joint trajectories and torque commands that modify the motion of the user's limbs. The feedback control loop uses real sensor readings to adjust actuator outputs, which ensures that improvements in classification accuracy and latency lead to measurable improvements in smoothness, stability, and safety of the physical motion.

The user wears the sensor unit and the robot unit and interacts with the system by intentionally imagining specific actions. The user may also provide feedback, for example through a terminal interface or a hardware button, to indicate successful or unsuccessful assistance. The server incorporates this feedback into label refinement for adaptive learning. In this way, the user participates in the calibration of the intention-recognition model and the tuning of motion assistance without manually configuring algorithms.

In an alternative embodiment, the terminal performs part of the neural network inference using a compact model optimized for the terminal's processor, such as a reduced-precision convolutional network, while the server performs periodic retraining and distribution of updated model parameters. In another embodiment, the robot unit includes an additional local neural network that refines assistance intensity based on local sensor patterns, such as unexpected external forces, and the server trains this local network jointly with the main intention-recognition model using federated learning techniques. In yet another embodiment, the generative AI model proposes alternative signal-processing pipelines, such as different filter bands or time-window lengths, and the server evaluates these pipelines on stored datasets to choose configurations that reduce misclassification in specific frequency bands.

By combining structured signal preprocessing at the terminal, optimized neural inference and adaptive learning at the server, generative-AI-based design of model and control parameters, and closed-loop feedback control of a body-worn multi-joint drive mechanism, the system provides concrete improvements to computer technology, including increased processing efficiency, improved accuracy of intention recognition, reduced latency in issuing motion commands, and reduced communication load between devices, while directly controlling real-world machinery for motion assistance.

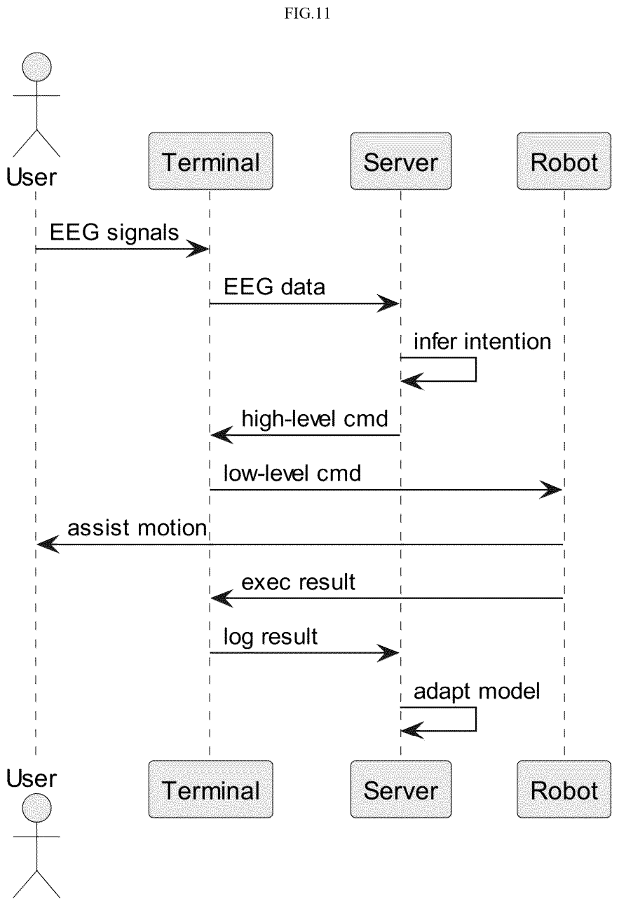

The following describes the processing flow using FIG. 11.

### Step 1:

The user places the EEG sensor unit on the scalp and keeps still. The user provides a physical input in the form of bioelectrical brain activity corresponding to an intended action, such as thinking about starting to walk or lifting an object. Based on this input, the EEG headset generates analog voltage signals on multiple electrodes that represent time-varying bioelectrical potentials, and outputs these analog signals to the terminal through a wired or wireless interface.

### Step 2:

The terminal receives the analog bioelectrical signals from the EEG sensor unit as an input stream. The terminal uses an analog-to-digital converter in the EEG headset to sample each channel at a predetermined sampling frequency and to produce discrete digital values. Based on these digital values, the terminal writes samples into a circular buffer in memory, thereby producing as output a sequence of raw digital EEG samples indexed by time and channel.

### Step 3:

The terminal takes the raw digital EEG samples from the circular buffer as input. The terminal applies a band-pass filter to each channel by convolving the input samples with a finite impulse response filter and removing frequency components outside a predetermined band, and applies a notch filter by subtracting from the samples a component at the power-supply frequency. As a result of these data operations, the terminal produces as output a noise-reduced EEG signal for each channel, in which slow drifts and power-line interference are attenuated.

### Step 4:

The terminal takes the noise-reduced EEG signals as input. The terminal normalizes the samples on each channel by computing a moving mean and standard deviation over a window and then subtracting the mean and dividing by the standard deviation for each sample. The terminal segments the normalized samples into time windows of fixed length, such as one second, and labels each window with a time stamp and channel identifiers. The terminal outputs structured data segments, each containing a two-dimensional array of normalized samples and associated metadata.

### Step 5:

The terminal takes the structured data segments as input. The terminal establishes an encrypted network connection to the server using a communication library and packages each data segment into a message format containing headers and payload. Based on these packaged messages, the terminal sends them over the network to the server, and outputs a stream of encrypted, structured time-series messages at a rate determined by the window length.

### Step 6:

The server receives the encrypted messages from the terminal as input. The server uses a decryption module to recover the structured data segments, parses the headers, and stores the payloads in a time-series storage system indexed by user identifier and time stamp. The server converts each two-dimensional array of samples into a tensor representation compatible with a neural network library by arranging dimensions as channels by time and, if necessary, batches several segments together. The server outputs a batch of input tensors prepared for inference.

### Step 7:

The server takes the batch of input tensors as input to a trained convolutional-recurrent neural network model. The server performs convolution operations along the channel and time dimensions using learned kernels to extract spatial-temporal features. The server then passes the resulting feature maps through a recurrent layer, such as a long short-term memory layer, that updates hidden states based on the current feature vector and the previous hidden state. From these computations, the server produces as output a set of intention probability vectors, where each vector contains a probability for each predefined action class, such as “start walking,” “stop walking,” “lift object,” and “move hand.”

### Step 8:

The server receives the intention probability vectors as input. The server compares each probability vector to a confidence threshold and selects the action class with the highest probability when the highest probability exceeds the threshold; otherwise, the server selects a “no action” or rejection class. The server maps the selected action to a high-level motion command by assigning a motion type, a target body part, and an assistance intensity based on the magnitude of the selected probability. The server outputs high-level motion command data structures that encode these parameters along with a time stamp.

### Step 9:

The server takes the high-level motion command data structures as input. The server uses a messaging module to serialize these data structures into messages and sends the messages back to the terminal over a low-latency, secure communication channel. As a result of this data transmission, the server outputs a stream of high-level motion command messages that correspond in time to recognized user intentions.

### Step 10:

The terminal receives the high-level motion command messages from the server as input. The terminal deserializes each message, extracts the motion type, target body part, and assistance intensity, and consults a local mapping table or parameterized function to transform these abstract parameters into specific joint trajectories and control parameters for the multi-joint drive mechanism. The terminal computes a sequence of joint waypoints and allowable torque or force limits and outputs low-level control command data that define desired joint angles, velocities, and safety constraints.

### Step 11:

The terminal takes the low-level control command data as input. The terminal encapsulates the joint commands into a format suitable for a local communication bus and transmits the commands to the robot unit using a short-range communication protocol. Based on these transmissions, the terminal outputs a timed sequence of actuator commands addressed to the processors of the multi-joint drive mechanism.

### Step 12:

The robot unit receives the low-level control command data as input. The robot unit interprets the commands as target joint trajectories and loads the trajectories into a controller buffer. The robot unit reads sensor values, including joint angles, angular velocities, and forces, at a fixed control period. For each control cycle, the robot unit computes an error between the target joint state and the measured joint state and applies a feedback control law, such as a proportional-integral-derivative computation, to produce actuator drive signals. The robot unit outputs motor voltages or currents that cause physical joint motion, thereby producing a body-worn motion assistance effect for the user.

### Step 13:

The robot unit takes the sensor readings and the target trajectories as input during motion assistance. The robot unit determines whether the motion has been successfully executed within tolerance limits or whether a safety condition has occurred, such as excessive force or a user-activated stop switch. The robot unit generates execution result information that indicates success, failure, interruption, or error codes and transmits this information to the terminal. The robot unit outputs structured status messages that summarize the outcome of each motion command.

### Step 14:

The terminal receives the execution result messages from the robot unit as input. The terminal associates each execution result with the corresponding high-level motion command and time stamp and forwards this combined information to the server over the encrypted network connection. As a result, the terminal outputs a log of execution results aligned with the motion commands and the original EEG data windows.

### Step 15:

The server receives the logs of execution results and associated identifiers as input. The server correlates these logs with the stored time-series data and intention outputs to construct labeled datasets, where each EEG segment is associated with a confirmed intention label and an outcome label. The server partitions the data into training and validation sets and feeds the training set into a learning algorithm that computes loss values, gradients, and weight updates for the convolutional and recurrent layers. After iterative optimization, the server outputs updated model parameters that improve classification accuracy and reduce false activations for the specific user.

### Step 16:

The server takes the current model configuration, performance metrics, and design requirements as input. The server generates at least one prompt sentence that specifies desired architecture changes or control rules, such as:

“Design a CNN-RNN model for 8-channel EEG data with reduced inference latency while maintaining accuracy above 90 percent for the classes ‘start walking’, ‘stop walking’, ‘lift object’, and ‘move hand’.”

The server provides this prompt sentence to a generative AI model and receives as output a proposed configuration describing layer types, kernel sizes, hidden dimensions, and control parameter relationships. The server parses this output into concrete configuration parameters for the neural network and control laws, and then uses these parameters as input to further training and evaluation. In this way, the server outputs refined computational structures that are systematically generated rather than manually tuned.

### Step 17:

The server receives the updated model parameters and refined configuration parameters as input. The server evaluates the updated model on the validation set by computing accuracy, precision, recall, and false positive rates for each intention class. If the performance satisfies predefined improvement criteria, the server deploys the updated model into the inference service by replacing previous weights and configuration settings. The server outputs a new version of the intention-recognition and control-mapping pipeline that is used in subsequent steps for real-time operation, thereby closing the loop of adaptive learning and generative design.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional assistive systems that use biological signals such as brain activity to control motion assistance devices suffer from several technical limitations in computer technology. First, conventional signal processing pipelines often treat biological signal acquisition, feature extraction, intention classification, and actuator control as loosely coupled components, resulting in high end-to-end latency, unstable intention estimation, and inconsistent assistance behavior. Second, existing systems typically rely on static machine learning models that are trained offline and deployed without continuous adaptation, so model performance degrades when the statistical properties of the subject's biological signals change over time, leading to reduced accuracy and increased misclassification. Third, current motion assistance controllers generally use fixed control parameters that do not take into account updated inference confidence, user-specific preferences, or continuous feedback from sensors and users, thereby limiting the ability to produce smooth and natural movements while maintaining safety constraints. Fourth, the design and improvement of neural network architectures and control algorithms in known systems usually require manual expert engineering, and there is no integrated computer-implemented mechanism to automatically propose, validate, and deploy new model structures or control rules based on system performance and updated requirements. As a result, known systems are unable to efficiently improve the underlying computer-implemented algorithms in response to real-world usage, which constrains scalability, maintainability, and robustness of intention recognition and motion assistance. There is therefore a need for a computer-implemented technique that tightly integrates biological signal acquisition, hierarchical learning-based intention inference, closed-loop motion assistance control, continuous model relearning, and automatic algorithm design using a generative AI model, in order to improve the functioning of the overall computing system, reduce processing latency, increase inference accuracy, and provide adaptive and safe assistance to the subject.

The specific processing by the specific processing unit 290 of the data processing device 12 in Application Example 1 is realized by the following means.

The present invention provides a server comprising a processor configured to acquire biological signal time-series data representing brain activity of a subject via a communication path from a terminal apparatus that segments the biological signal time-series data into time windows and performs noise reduction processing and normalization processing on each time window, to verify and buffer the time-windowed biological signal time-series data and convert the time-windowed biological signal time-series data into feature data acceptable as input to a hierarchical learning model, to execute inference processing by the hierarchical learning model in order to select and identify an intended action of the subject from among a plurality of action classes, to generate motion command information including a type of assistance motion, joint trajectories, and output limitation values on the basis of the identified action class and subject-specific setting information, and to transmit the motion command information to a motion assistance apparatus via the communication path, to store in a storage medium the biological signal time-series data, the identified action class, the motion command information, and evaluation information from a user, and to perform continuous relearning of the hierarchical learning model on the basis of stored data so as to update intention estimation accuracy and suitability of the assistance motion, and to transmit a prompt sentence described in natural language to an external generative AI model, receive model configuration information or control algorithm information from the external generative AI model in response to the prompt sentence, and automatically design or improve at least one of the hierarchical learning model and a control rule for the motion assistance apparatus on the basis of the received model configuration information or control algorithm information. This enables the computing system to implement an integrated, low-latency pipeline from biological signal acquisition to motion assistance control, to adapt the machine learning model and control logic to individual subjects and temporal changes in biological signals, to improve accuracy and stability of intention inference through continuous relearning, and to automatically refine internal model architectures and control algorithms using the external generative AI model, thereby improving the technical performance, efficiency, and robustness of the computer-implemented assistive platform.

The term “processor” refers to a hardware information processing element, such as a central processing unit or graphics processing unit, that executes machine-readable instructions to perform data processing, inference, control, and communication operations described in the present disclosure.

The term “biological signal” refers to an electrical or physiological signal generated by a living body, including brain activity signals measurable as electroencephalographic signals, that can be sampled as time-series data for computational analysis.

The term “biological signal time-series data” refers to a sequence of sampled values of a biological signal acquired over time at a predetermined sampling rate, which can be processed as a digital data stream by the processor.

The term “biological signal acquisition apparatus” refers to a hardware unit configured to measure a biological signal of a subject, the hardware unit including a plurality of electrodes attached to a body surface and associated circuitry for converting analog biological signals into digital data.

The term “electrode” refers to a sensing element that is configured to contact a body surface of a subject and to detect electrical potential differences corresponding to biological signals.

The term “subject” refers to a human or other living body from which biological signals are acquired and to whom motion assistance is provided by the system.

The term “terminal apparatus” refers to an information processing device, such as a portable computing device or wearable computing device, that is configured to receive biological signal time-series data from the biological signal acquisition apparatus, perform local preprocessing, and transmit processed data to the server.

The term “time window” refers to a segment of biological signal time-series data having a defined temporal length and optionally an overlap with adjacent segments, which is processed as a unit for feature extraction and inference by the processor.

The term “noise reduction processing” refers to signal processing operations, such as filtering or artifact removal, applied to biological signal time-series data to suppress unwanted components including environmental noise, motion artifacts, and power-line interference.

The term “normalization processing” refers to a transformation applied to biological signal time-series data, such as scaling, offset adjustment, or statistical standardization, to place the data into a form suitable for input to a machine learning model.

The term “communication path” refers to a logical or physical communication channel, including wired or wireless links and associated protocols, that is configured to transmit data between the terminal apparatus, the processor, and a motion assistance apparatus.

The term “feature data” refers to numerical representations derived from biological signal time-series data, including extracted or transformed values, which are formatted as inputs to a machine learning model for inference.

The term “machine learning model” refers to a parameterized computational model, trained on data, that is configured to map input feature data to output predictions such as an intended action of a subject.

The term “hierarchical learning model” refers to a machine learning model including multiple processing layers arranged in a hierarchy, such as convolutional layers and recurrent layers, that collectively perform feature extraction and temporal pattern analysis on biological signal time-series data.

The term “convolutional layer” refers to a layer of the hierarchical learning model that applies convolution operations to input data to extract spatial or frequency-domain features across channels or time samples.

The term “recurrent layer” refers to a layer of the hierarchical learning model that maintains internal state across time steps, such as a recurrent neural network, and that is configured to analyze temporal patterns in sequential input data.

The term “action class” refers to a predefined category representing a type of intended behavior or movement of the subject, such as standing up, walking, sitting, or no action, which can be selected by the hierarchical learning model as an inference output.

The term “intended action” refers to an action that the subject is attempting or planning to perform, as inferred from biological signal time-series data by the hierarchical learning model.

The term “subject-specific setting information” refers to configuration data associated with an individual subject, including preferred assistance levels, movement speed limits, safety constraints, or personalized thresholds used for generating motion command information.

The term “motion command information” refers to data describing a planned assistance motion, including a type of assistance motion, joint trajectories, and output limitation values, which is transmitted from the processor to the motion assistance apparatus for execution.

The term “joint trajectory” refers to a time-varying specification of desired joint states, including positions, velocities, or accelerations, for one or more joints of the motion assistance apparatus during execution of an assistance motion.

The term “output limitation value” refers to a constraint applied to the motion assistance apparatus, such as a maximum torque, force, or speed value, to ensure safe operation in assisting the subject's movement.

The term “motion assistance apparatus” refers to a mechanical device including actuators and sensors, such as an exoskeletal device or a robotic manipulator, that is configured to provide physical assistance to at least one limb of the subject in response to motion command information.

The term “drive element” refers to an actuator or actuator assembly, such as a motor or linear actuator, of the motion assistance apparatus that generates mechanical output to move a structure in accordance with control signals.

The term “posture information” refers to data representing the pose or configuration of at least part of the subject's body or of the motion assistance apparatus, including joint angles, positions, or orientations.

The term “force information” refers to data representing interaction forces or torques, such as loads on joints or contact forces between the subject and the motion assistance apparatus, measured by sensors.

The term “body movement” refers to a change in position or posture of at least a portion of the subject's body, including movements of lower limbs or upper limbs that can be assisted by the motion assistance apparatus.

The term “storage medium” refers to a physical data storage element, such as a memory device or non-volatile storage device, that is configured to store biological signal time-series data, inference results, command data, and user evaluation information. The term “evaluation information” refers to data provided by a user or derived from system performance metrics, indicating quality or appropriateness of assistance, such as satisfaction scores, success or failure indicators, or error measurements.

The term “continuous relearning” refers to a process in which a machine learning model is updated or retrained over time using newly accumulated data while maintaining previously acquired knowledge, in order to adapt to changes in biological signals or user behavior.

The term “intention estimation accuracy” refers to a quantitative measure of how correctly the hierarchical learning model identifies intended actions of the subject based on biological signal time-series data.

The term “suitability of the assistance motion” refers to a measure of how well the motion assistance apparatus's executed assistance motion matches the subject's intended action and individual support needs.

The term “prompt sentence” refers to a natural-language instruction or query generated by the processor and supplied to an external generative AI model to request generation of model configuration information, control algorithm information, or other design-related information.

The term “external generative AI model” refers to a machine learning system, separate from the processor, that generates text, code, or structured data in response to natural-language input, and is accessible via a communication interface.

The term “model configuration information” refers to data specifying structural or training-related aspects of a machine learning model, including layer types, parameter sizes, hyperparameters, or training procedures.

The term “control algorithm information” refers to data describing computational procedures or rules for controlling the motion assistance apparatus, including feedback control laws, state machines, or safety constraints.

The term “control rule” refers to a logical or mathematical specification used by the processor or motion assistance apparatus to determine control outputs, such as actuator commands, from sensed data and motion command information.

In one embodiment, the system includes a server, a terminal, a biological signal acquisition apparatus, and a motion assistance apparatus. The server includes at least one processor and at least one storage device. The terminal is implemented, for example, as a smartphone, tablet computer, or wearable computing device. The biological signal acquisition apparatus is implemented, for example, as an EEG headset including multiple electrodes and an analog front-end circuit. The motion assistance apparatus is implemented, for example, as a powered exoskeleton or a care robot including actuators, joint sensors, and force sensors. The user wears the biological signal acquisition apparatus on the head and wears or is physically coupled to the motion assistance apparatus. The user carries or operates the terminal. The terminal executes an application program that communicates with the biological signal acquisition apparatus and the server. The server executes a server-side software stack including a communication module, a signal processing module, a machine learning module, a control command generation module, a learning management module, and an interface module to an external generative AI model.

The terminal uses a device driver or vendor SDK to configure the biological signal acquisition apparatus. The terminal sets parameters such as sampling rate, channel mapping, amplifier gain, and filter settings. The terminal uses a digital signal processing library, for example a generic digital filter library or a numerical computation library, to perform band-pass filtering and notch filtering on the digitized EEG signals. The terminal maintains the digitized EEG data in a ring buffer or sliding window data structure stored in main memory. The terminal segments the continuous stream into fixed-length windows, for example windows of 256 or 512 samples per channel, and represents each window as a multi-dimensional array with dimensions corresponding to channels and time indices.

The terminal performs noise reduction processing on each window. The terminal applies, for example, a finite impulse response band-pass filter between 0.5 Hz and 40 Hz and a notch filter at 50 Hz or 60 Hz. The terminal optionally applies an adaptive filter that estimates and removes baseline drift. The terminal computes signal quality metrics, such as variance, amplitude clamping, and channel-wise signal-to-noise indicators. When the metrics indicate poor signal quality, the terminal displays a graphical notification prompting the user to adjust electrode positions or contact pressure.

The terminal performs normalization processing on each window. The terminal calculates, for example, a mean and standard deviation per channel over a short recent history and converts the raw values to z-scores. The terminal then encapsulates each normalized window together with metadata, such as user identifier, channel configuration, timestamp, and quality scores, into a structured payload, for example a binary or structured message format. The terminal uses a cryptographic library to encrypt the payload and transmits the payload to the server over a wireless communication link such as Wi-Fi or Bluetooth Low Energy.

The server receives the transmitted payloads via a network interface. The server uses operating system networking facilities to accept connections from multiple terminals. The server uses a decryption library to decrypt the payload and a validation module to verify checksums, data length, and metadata consistency. The server discards malformed payloads and logs corresponding error information. The server associates each valid payload with a per-user buffer maintained in volatile memory. The server thus builds a sequence of normalized time-windowed biological signal data for each user.

The server converts each time-windowed biological signal into feature data suitable for input to a hierarchical learning model. The server uses, for example, a numerical computation framework to reshape the data into a tensor of shape [channels x time samples]. The server applies optional additional transforms, such as short-time Fourier transform or wavelet transform, to augment the data with frequency-domain features. The server may concatenate raw time-domain values and frequency-domain magnitudes along a feature dimension. This explicit construction of multi-domain feature tensors improves the ability of the subsequent convolutional layers to capture relevant spatial-frequency patterns and thus increases classification accuracy.

The server implements the hierarchical learning model using a deep neural network framework such as a generic tensor computation framework. The server configures a sequence of layers including, for example, two-dimensional convolutional layers, activation layers such as rectified linear units, pooling layers, and recurrent layers such as gated recurrent units or long short-term memory units. The server sets hyperparameters such as number of convolutional filters, filter sizes, stride sizes, number of recurrent units, and number of layers to match the dimensions of the EEG feature tensors and the target action classes.

The server uses a GPU or other accelerator to execute matrix multiplications and convolution operations for inference. The server feeds each feature tensor into the hierarchical learning model and performs a forward pass to compute logits for multiple action classes such as “stand up,” “walk,” “sit,” and “no action.” The server applies a softmax function to convert logits to probabilities. The server compares these probabilities against thresholds and applies temporal smoothing rules, such as a sliding majority vote over several consecutive windows, to stabilize the predicted intended action. This non-conventional combination of deep temporal inference and window-level voting reduces spurious fluctuations that would otherwise result from noise, thereby reducing error rates in intention estimation.

The server stores the identified intended action, the corresponding probabilities, the original feature tensor references, and motion assistance context information in a database. The server maintains, for each user, a history of inferred actions and associated confidence scores. The server also stores user-specific setting information, such as preferred assistance intensity, maximum joint torque limits, and motion speed limits, in a user profile data structure.

The server generates motion command information when the hierarchical learning model identifies a valid intended action with sufficient confidence. The server uses a control command generation module that maps each action class to a reference motion pattern. For example, when the intended action is “stand up,” the server selects a pre-defined or learned joint trajectory template for hip and knee joints. The server scales the trajectory based on user-specific parameters and on the current state of the motion assistance apparatus, such as current joint angles and whether the user is already partially standing.

The server represents each joint trajectory as a sequence of time-stamped setpoints. Each setpoint includes desired joint position, velocity, and optionally torque or impedance parameters. The server attaches output limitation values to the motion command information, such as maximum torque and maximum joint angle ranges, derived from the user profile. The server assembles the motion command information into a structured control message and transmits the control message to the motion assistance apparatus through a low-latency communication channel.

The motion assistance apparatus includes a local controller that receives the motion command information from the server. The motion assistance apparatus measures posture information by reading joint angle sensors, encoder outputs, or inertial measurement units. The motion assistance apparatus measures force information by reading load cells, torque sensors, or pressure sensors. The motion assistance apparatus performs feedback control by computing, at high frequency, the difference between the desired joint states in the motion command information and the actual joint states. The motion assistance apparatus uses these errors to compute actuator commands, for example through proportional-integral-derivative control or model-based control laws implemented in embedded firmware.

The motion assistance apparatus enforces the output limitation values specified by the server. When a computed actuator command exceeds a maximum allowed torque or speed, the motion assistance apparatus saturates the command at the limit and may trigger an internal safety routine. This explicit separation between high-level intention-based motion planning on the server and low-level bounded control on the motion assistance apparatus ensures both responsiveness and safety. The motion assistance apparatus thus generates smooth, coordinated assistance motions that align with the user's intended actions and reduce the physical load required for standing up, walking, or similar movements.

The server implements a learning management module to perform continuous relearning of the hierarchical learning model. The server stores biological signal time-series data, identified action classes, motion command information, sensor feedback from the motion assistance apparatus, and user evaluation information in a storage system. The user provides evaluation information, for example by operating the terminal to indicate “assistance was helpful,” “assistance was too strong,” or “assistance was delayed.” The server associates such evaluations with the corresponding time ranges of biological signals and motion commands.

The server periodically initiates a training procedure. The server constructs training datasets by sampling windows of biological signal data and labeling them with ground truth or corrected intended actions derived from historical data, device feedback, and user evaluations. The server divides the data into training, validation, and test subsets. The server applies data augmentation methods, for example adding small Gaussian noise, temporal shifting, or frequency-band perturbation, to increase robustness of the model to real-world variability.

The server defines a loss function, such as cross-entropy loss for multi-class classification combined with regularization terms that penalize abrupt changes in predicted actions across time. The server uses an optimization algorithm such as stochastic gradient descent or Adam to update the weights of the convolutional and recurrent layers. The server computes gradients by backpropagation and adjusts the weights iteratively. The server monitors validation metrics such as classification accuracy, Fl score, and latency of inference. The server stores multiple versions of trained models and compares their performance.

The server selects a candidate updated model when it observes improved intention estimation accuracy and stable performance metrics. The server then deploys the updated model to the online inference environment by replacing or versioning the model parameters used by the inference module. The server performs this deployment in a controlled manner, for example by switching users incrementally to the new model and monitoring for regressions. This continuous relearning mechanism allows the system to adapt to gradual changes in the user's biological signals and behavior, improving long-term accuracy and reducing misclassification without requiring manual recalibration.

The server uses an external generative AI model to assist in designing and improving internal models and control algorithms. The server constructs prompt sentences in natural language that describe current requirements, constraints, and observed performance issues. The server transmits these prompt sentences, together with structured performance summaries, to the external generative AI model through an application programming interface. The server then receives generated text that proposes, for example, modified network architectures, alternative hyperparameter settings, or improved control loop structures.

For example, the server may generate and transmit a prompt sentence such as: “The server must design an improved CNN-RNN model for decoding multi-channel EEG signals into discrete intentions like ‘stand up’ and ‘walk.’ The model must be robust to noise, support online inference on GPU hardware, and include recommendations for data augmentation and continual learning. Please output layer definitions, hyperparameters, and a brief training procedure.”

In another example, the server may generate and transmit a prompt sentence such as: “The server must propose a feedback control strategy for a lower-limb exoskeleton that assists standing up and walking based on high-level intention commands. The strategy should define joint-level PID controllers, safety constraints, and a state machine for transitions between sitting, standing, and walking. Please describe the control loop and message structure used between the server and the robot controller.”

In another example, the server may generate and transmit a prompt sentence such as: “The server must generate a method for personalizing intention-recognition thresholds and assistance levels based on each user's EEG patterns and feedback ratings. The method should specify how to adjust decision thresholds, how to cluster users with similar EEG responses, and how to update parameters over time without degrading safety.”

The server parses the responses generated by the external generative AI model. The server extracts concrete descriptions such as proposed layer counts, filter sizes, sequence lengths, learning rates, and control state transitions. The server does not adopt the generated content directly in production. Instead, the server instantiates candidate models or control strategies in a sandbox environment, runs offline or simulated evaluations, and compares performance with existing implementations. Only when the server determines that a candidate design achieves predefined improvement criteria does the server integrate the design into the live system. This procedure demonstrates that the use of the generative AI model is not a mere automation of human design, but part of a computer-implemented feedback loop that systematically searches and validates algorithmic improvements, thereby enhancing the technical performance of the system.

The server thus improves computer technology in several ways. The server reduces end-to-end latency by using a specific dataflow: terminal-side pre-processing, compact feature tensor construction, and GPU-accelerated hierarchical inference. The server improves accuracy and robustness by combining convolutional layers and recurrent layers tuned to the statistics of biological signals and by implementing temporal smoothing and continuous relearning. The server improves data management by storing structured associations between biological signals, model predictions, control commands, sensor feedback, and user evaluations, facilitating targeted retraining and auditing. The server reduces communication load by performing normalization and filtering on the terminal and by transmitting only time-windowed, compressed representations rather than continuous raw signals. The server increases safety and motion quality by generating motion commands that encode explicit joint trajectories and output limitation values and by coordinating these commands with feedback control in the motion assistance apparatus.

The terminal contributes to these technical effects by performing initial filtering and normalization so that the server can focus computational resources on deep inference rather than raw signal cleanup. The terminal's segmentation into fixed time windows and use of compact payload formats reduce the amount of data transmitted, which lowers network congestion and power consumption. The user interacts with the terminal primarily to provide evaluation information and adjust preferences. The system uses this information not as simple annotations but as structured labels that directly influence loss functions, decision thresholds, and assistance profiles during retraining and personalization.

Alternative embodiments are possible. The server may implement the hierarchical learning model with different combinations of layers, such as temporal convolutional networks instead of recurrent layers, or may use attention mechanisms to weight contributions from different time steps. The server may use different loss functions, such as focal loss or margin-based losses, depending on class imbalance. The terminal may run on different operating systems and may implement different noise reduction algorithms. The motion assistance apparatus may use different actuator technologies, such as pneumatic actuators or hydraulic actuators, and different sensor configurations. The external generative AI model may be provided by different service providers or may run on a separate local machine under control of the server.

In all embodiments, the server, the terminal, and the motion assistance apparatus cooperate to implement a concrete, technical pipeline that transforms biological signal time-series data into real-time physical assistance for the user. The architecture and processing flow are specifically designed to improve computational efficiency, inference accuracy, and control stability beyond what could be achieved by manual tuning or conventional static models, thereby providing a technological improvement in the field of computer-implemented assistive systems.

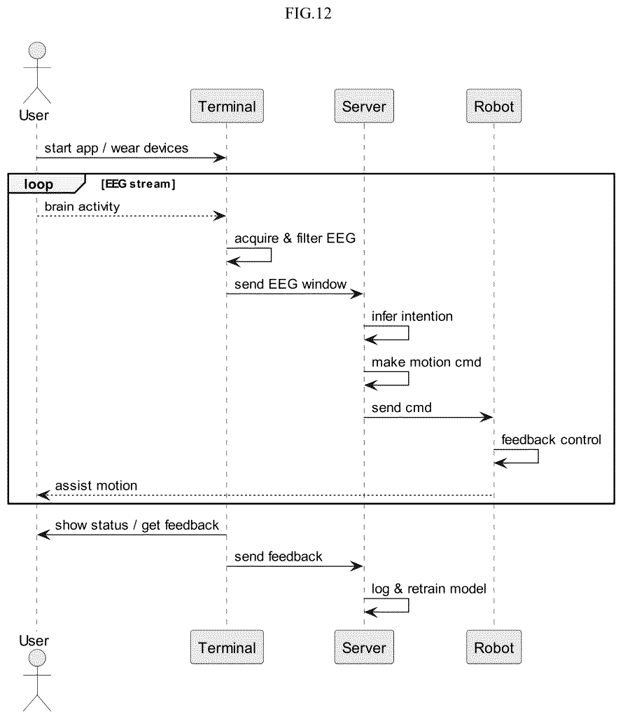

The following describes the processing flow using FIG. 12.

### Step 1:

The user wears the biological signal acquisition apparatus and the motion assistance apparatus and starts the application on the terminal.

The user provides an implicit input in the form of brain activity related to an intended action such as standing up or walking.

The terminal receives as input configuration parameters (sampling rate, channel list) and user identification from local storage.

The terminal outputs initialized device settings and a ready state for biological signal acquisition.

### Step 2:

The terminal acquires raw biological signal samples from the biological signal acquisition apparatus through a device driver interface.

The terminal receives as input analog-to-digital converted samples for multiple channels at a fixed sampling rate.

The terminal stores these samples into a ring buffer data structure in main memory and outputs a continuous digital time-series stream organized per channel and timestamp.

### Step 3:

The terminal performs signal conditioning and segmentation of the time-series stream.

The terminal takes as input the continuous multi-channel digital time-series data from the ring buffer.

The terminal applies band-pass filtering and notch filtering to remove baseline drift, low-frequency noise, and power-line interference; the terminal then divides the filtered stream into fixed-length, possibly overlapping time windows (for example, 1-second windows). The terminal outputs a sequence of preprocessed time windows, each represented as a multi-dimensional array with dimensions [channels× time samples].

### Step 4:

The terminal performs normalization and quality assessment of each time window.

The terminal receives as input a single preprocessed time window and recent historical statistics per channel.

The terminal computes a mean and standard deviation per channel and transforms each sample to a normalized value (for example, z-score), and calculates quality metrics such as per-channel variance and amplitude range.

The terminal outputs a normalized time window together with metadata including timestamp, user identifier, quality metrics, and channel configuration.

### Step 5:

The terminal secures and transmits the normalized data to the server.

The terminal receives as input the normalized time window and associated metadata.

The terminal encrypts the combined data using a cryptographic algorithm and packages the encrypted payload into a communication frame with headers (including user identifier, sequence number, and checksum).

The terminal outputs the encrypted communication frame and sends it through a wireless or wired communication interface to the server.

### Step 6:

The server receives and validates the communication frame from the terminal.

The server receives as input the encrypted communication frame from the network interface.

The server decrypts the frame, verifies the checksum, checks metadata consistency (for example, channel count and sampling rate), and discards or logs any invalid frames.

The server outputs validated normalized time windows and metadata and stores them in a per-user buffer in volatile memory.

### Step 7:

The server converts each normalized time window into feature data suitable for the hierarchical learning model.

The server receives as input a validated normalized time window and associated metadata from the per-user buffer.

The server reshapes the data into a tensor structure, optionally computes additional transforms such as frequency spectra or wavelet coefficients, and concatenates time-domain and frequency-domain values along a feature dimension.

The server outputs a feature tensor representing spatial, temporal, and frequency characteristics of the biological signal for further inference.

### Step 8:

The server executes intention inference using the hierarchical learning model.

The server receives as input the feature tensor and model parameters of the convolutional and recurrent layers.

The server performs a forward pass: applying convolutional operations along channel and time axes, applying nonlinear activation and pooling, and then feeding the resulting sequence into recurrent units to capture temporal dependencies, followed by a fully connected layer and softmax to compute class probabilities.

The server outputs a probability vector over possible action classes and a selected intended action with an associated confidence score.

### Step 9:

The server stabilizes and validates the intended action over time.

The server receives as input the current probability vector and intended action, along with recent history of predictions for the same user.

The server applies temporal smoothing rules, such as majority voting over a sliding window of recent predictions and minimum duration constraints, and checks whether the confidence score exceeds a predefined threshold.

The server outputs a stabilized intended action label or a “no reliable action” indication and an updated internal state for the smoothing logic.

### Step 10:

The server generates motion command information based on the stabilized intended action.

The server receives as input the stabilized intended action, the user profile parameters (such as assistance level and joint limits), and the latest reported state of the motion assistance apparatus.

The server selects a reference motion pattern, scales joint trajectories according to user-specific limits, and computes a sequence of desired joint states (positions, velocities, and optionally torques) over time, while applying output limitation values to enforce safety.

The server outputs structured motion command information including the type of assistance motion, time-stamped joint trajectories, and explicit torque and angle limits.

### Step 11:

The server transmits motion command information to the motion assistance apparatus.

The server receives as input the motion command information structure for the current intended action.

The server serializes the command information into a control message format, attaches identifiers and timestamps, and sends the message through a low-latency communication channel to a controller of the motion assistance apparatus.

The server outputs the transmitted control message and records a log entry associating the message with the originating intended action and time window.

### Step 12:

The motion assistance apparatus executes feedback control based on the received motion command information.

The motion assistance apparatus receives as input the control message containing desired joint trajectories and output limits.

The motion assistance apparatus reads posture information and force information from internal sensors at a high control rate, computes tracking errors between desired and actual joint states, and generates actuator commands using feedback control laws while enforcing torque and velocity limits.

The motion assistance apparatus outputs physical motion of the actuators that assists the user's body movement and status data reporting sensor readings and control performance back to the server.

### Step 13:

The terminal provides a user interface for status display and feedback input.

The terminal receives as input status and summary information from the server, including current intended action, assistance mode, and alerts.

The terminal renders this information on a display, allows the user or caregiver to adjust configuration parameters, and collects feedback such as “assistance too strong” or “assistance delayed” via user interactions.

The terminal outputs user feedback messages and configuration updates to the server for use in model adaptation and parameter adjustment.

### Step 14:

The server records operational data for later analysis and relearning.

The server receives as input biological signal windows, feature tensors, inferred intended actions, motion command information, sensor feedback from the motion assistance apparatus, and user feedback messages.

The server stores these data elements in a structured database, linking them by timestamps, user identifiers, and session identifiers, and organizes them into datasets suitable for supervised and semi-supervised learning.

The server outputs persistent records that capture the full context of system operation and are retrievable for training and evaluation tasks.

### Step 15:

The server performs continuous relearning of the hierarchical learning model.

The server receives as input stored datasets comprising biological signal windows and corresponding labels or corrected actions derived from historical operation and user feedback.

The server constructs training, validation, and test sets, applies data augmentation (for example, additive noise and temporal shifts), computes a loss function such as cross-entropy with regularization, and performs weight updates of convolutional and recurrent layers using gradient-based optimization.

The server outputs updated model parameters, improved evaluation metrics, and a selected model version for deployment.

### Step 16:

The server deploys the updated hierarchical learning model to the online inference environment.

The server receives as input the updated model parameters and associated performance metrics from the training process.

The server loads the updated parameters into the inference module, performs integrity checks, and gradually routes incoming feature tensors to the new model while monitoring real-time accuracy and latency.

The server outputs an active model instance that replaces or supplements the previous model, thereby improving intention estimation performance during ongoing operation.

### Step 17:

The server collaborates with an external generative AI model to search for improved architectures and control strategies.

The server receives as input system performance summaries, such as confusion matrices, latency statistics, and control stability indicators.

The server generates a prompt sentence describing requirements for improved EEG decoding, control algorithms, or personalization, transmits the prompt sentence and relevant structured data to the external generative AI model, and receives textual proposals specifying architectural changes, new hyperparameters, or control logic modifications.

The server outputs candidate design specifications that can be instantiated as new hierarchical learning models or control modules for further offline evaluation.

### Step 18:

The server evaluates and integrates candidate designs proposed via the generative AI model.

The server receives as input candidate model and control descriptions derived from the generative AI output and the current baseline implementations.

The server instantiates candidate models or control schemes in a sandbox environment, runs offline replay of recorded datasets, compares metrics such as accuracy, error rate, and response time, and selects only those candidates that meet predefined improvement thresholds.

The server outputs integrated, improved models or control strategies into the production system, thereby closing the loop between generative AI-assisted design and real-world performance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional motion support systems that use brain activity signals to infer user intention and control an assistive device primarily focus on mapping sensed signals to control commands. Such systems often treat signal processing, intention inference, and device control as fixed pipelines configured at design time. As a result, several technical problems arise in terms of computer technology.

First, existing systems typically employ a single learning model that estimates user intention from brain-related signals without jointly modeling biological signals and emotional states. This architecture constrains the feature space used by the processor and limits the robustness and adaptability of inference under noise, variability across users, and changing physiological conditions. The processor thus suffers from reduced inference accuracy and unstable control behavior, particularly when the user exhibits high anxiety, tension, or fatigue.

Second, control logic in conventional systems is usually handcrafted or manually tuned by developers and remains static during operation. The processor executes fixed parameter mappings (for example, from an intention class to speed and torque values) that do not systematically incorporate logged data from previous sessions. Consequently, the processor cannot efficiently exploit accumulated record information to improve models and control strategies at runtime, leading to suboptimal utilization of computation and memory resources and poor scalability across users and devices.

Third, most existing systems employ disjoint workflows for offline model design and online control. Even when large datasets are stored, the processor is not configured to dynamically refine learning models and control policies based on these logs while the system is deployed. This results in a technical bottleneck: hardware resources such as general-purpose processors and accelerators are under-utilized for continuous learning, and the system architecture cannot automatically evolve its internal algorithms based on observed performance.

Fourth, conventional architectures rarely leverage generative AI models as system-level components for algorithmic optimization. Existing use of generative models, if any, is typically limited to peripheral tasks, and generative models are not integrated into the core control and learning loop. Therefore, the processor does not generate structured prompt sentences based on record information and does not obtain machine-interpretable improvement proposals for control logic or learning algorithms. This prevents the system from using generative models as meta-optimizers of its own computational workflows, leading to a rigid and manually maintained software stack.

Accordingly, there is a need for a system in which a processor cooperatively manages acquisition of brain-related and biological signals, multi-model inference of user intention and emotional state, determination of motion parameters, and dynamic updating of learning models, while also generating prompt sentences to query a generative AI model for improvement proposals. Such a system should technically improve the way the processor organizes data flows, executes learning models on numerical tensors, and reconfigures control and learning processes based on structured feedback from both logged data and generative AI outputs. By solving these problems, the invention can enhance computational efficiency, adaptability, and robustness of intention-based motion support systems as implemented on general-purpose computing hardware.

The specific processing by the specific processing unit 290 of the data processing device 12 in Example 2 is realized by the following means.

The present invention provides a server comprising a processor configured to acquire brain-related signals and biological signals from a plurality of electrical signal measurement devices worn on a subject; to analyze the brain-related signals using a first learning model to estimate an intended action of the subject; to analyze the brain-related signals and the biological signals using a second learning model to estimate an emotional state of the subject; to determine motion parameters of a motion support mechanical element worn on a body part of the subject based on the estimated intended action and the estimated emotional state and to control the motion support mechanical element based on the determined motion parameters; to store record information including the brain-related signals, the biological signals, the estimated intended action, the estimated emotional state, and the motion parameters and to update at least one of the first learning model and the second learning model based on the record information; and to generate a natural language input sentence based on at least one of the record information and information relating to a control process or a learning process, to transmit the natural language input sentence as a prompt sentence to a generative AI model, to obtain an improvement proposal relating to at least one of a control logic and a learning algorithm from the generative AI model, and to update at least one of the control process and the learning process based on the improvement proposal. This enables the processor to implement a closed-loop computational architecture in which multimodal learning models, control parameter computation, and generative-AI-assisted optimization are integrated, thereby improving inference robustness, control adaptivity, and overall efficiency of computer resources in a motion support system.

The term “brain-related signals” refers to electrical or other measurable signals originating from neural activity in the brain of a subject and acquired by one or more sensing elements, and may include digitized time-series data representing brain waves or related neural activity patterns.

The term “biological signals” refers to electrical, mechanical, or other physiological signals originating from a body of a subject and acquired by one or more sensing elements, and may include heart-related signals, muscle-related signals, skin conductance signals, respiratory signals, or other signals indicative of autonomic or somatic activity.

The term “electrical signal measurement devices” refers to hardware apparatuses configured to detect brain-related signals or biological signals via electrodes, sensors, or transducers attached to a subject, to convert the detected signals into electrical signals, and to output the electrical signals to a processing unit in analog or digital form.

The term “first learning model” refers to a machine learning model whose internal parameters are trained based on labeled data so that, when brain-related signals or features derived therefrom are input, the model outputs an estimate of an intended action of a subject, such as an action class or a corresponding probability distribution.

The term “second learning model” refers to a machine learning model whose internal parameters are trained based on labeled data so that, when brain-related signals and biological signals or features derived therefrom are input, the model outputs an estimate of an emotional state of a subject, such as one or more continuous scores or categorical labels representing emotional conditions.

The term “intended action” refers to a physical action that a subject plans, imagines, or decides to perform, including but not limited to standing up, starting to walk, stopping walking, raising a limb, or lifting an object, and which is inferred from brain-related signals by the first learning model.

The term “emotional state” refers to a psychological or affective condition of a subject, including but not limited to anxiety, tension, fatigue, calmness, or satisfaction, which is represented by one or more continuous values, scores, or category labels output by the second learning model.

The term “motion support mechanical element” refers to a mechanical device configured to be worn on or coupled to a body part of a subject and to assist, augment, or substitute the subject's physical motion through actuation, and may include an exoskeleton mechanism, an articulated robotic limb, or a similar motion assistance apparatus.

The term “motion parameters” refers to numerical values or settings that define or constrain motion behavior of a motion support mechanical element, including but not limited to target positions, velocities, accelerations, torque limits, motion speed coefficients, assist torque coefficients, and start or stop conditions for movement.

The term “record information” refers to stored data generated during operation of the system, including at least brain-related signals, biological signals, estimated intended actions, estimated emotional states, motion parameters, and optionally user feedback or evaluation indices, which are used for analysis, learning, or optimization processes.

The term “control process” refers to a sequence of computational and communication operations executed by a processor to determine motion parameters based on estimated intention and emotional state and to generate and transmit control commands to a motion support mechanical element in order to cause the mechanical element to perform a desired motion.

The term “learning process” refers to a sequence of computational operations executed by a processor to update internal parameters of one or more learning models based on record information, including procedures such as training, fine-tuning, optimization, or adaptation of machine learning models or control policies.

The term “generative AI model” refers to a pre-trained machine learning model, such as a generative language model or a generative program synthesis model, configured to generate output data including text, parameter suggestions, or algorithmic proposals in response to an input sequence, based on patterns learned from a large training dataset.

The term “prompt sentence” refers to a sequence of natural language tokens or similar structured input provided to a generative AI model, the sequence specifying context, constraints, or desired types of output so that the generative AI model generates a corresponding response such as an improvement proposal for a control logic or a learning algorithm.

The term “improvement proposal” refers to information output by a generative AI model in response to a prompt sentence, the information including at least one of suggested values or ranges of motion parameters, modified control rules, proposed structures of state spaces or action spaces, or revised reward functions for use in a learning process.

The term “user evaluation index” refers to a quantitative or qualitative measure representing a user's assessment of system behavior or experience, including but not limited to survey scores for calmness or satisfaction, ratings of comfort or safety, or other feedback values associated with a session or event.

In one embodiment, a system includes a server, a terminal, and one or more motion support mechanical elements worn by a user, as well as electrical signal measurement devices configured to acquire brain-related signals and biological signals from the user. The server and the terminal each execute programs stored in a non-transitory computer-readable medium. The programs cause a processor to perform specific numerical computations, data transformations, and control operations as described below.

The user wears an EEG-type electrical signal measurement device on the head, one or more biological signal measurement devices such as a heart-rate sensor and a skin conductance sensor on the body, and at least one motion support mechanical element such as a multi-joint exoskeleton or an articulated robotic limb on a limb or trunk. The user also operates the terminal, which may be realized by a portable information processing device running a general-purpose operating system.

The terminal executes an application program implemented, for example, in a high-level programming language on a mobile operating system. The terminal uses wireless communication hardware and a communication stack such as Bluetooth and wireless LAN to establish data links with the electrical signal measurement devices and with the server. The terminal receives raw EEG samples, raw heart-related samples, and raw skin conductance samples as time-series data and performs digital signal processing on these data using a digital signal processing library such as a discrete Fourier transform library. The terminal converts the raw samples into preprocessed arrays by applying band-pass filters, notch filters, and baseline correction, and then encapsulates these arrays into structured data objects such as JSON-like records that contain arrays of values, channel indices, timestamps, and device identifiers. The terminal transmits these structured data objects to the server using an encrypted protocol such as HTTPS.

The server runs an operating system such as a server-class Unix-like system on one or more general-purpose processors and uses an accelerator such as a general-purpose graphics processing unit to perform numerical computations. The server executes an application program written, for example, in a scientific scripting language and uses numerical libraries such as array-processing libraries, scientific computation libraries, and data-frame libraries. The server receives the structured data objects from the terminal via an application programming interface and maps the serialized arrays into multidimensional numerical arrays (tensors) in main memory.

The server standardizes the brain-related signals by computing channel-wise means and variances over a calibration window and subtracting the means and dividing by the standard deviations for each channel. The server calculates derived biological features from the biological signals, such as heart rate variability indices computed from inter-beat intervals using time-domain and frequency-domain methods, and phasic and tonic components of skin conductance computed by separating fast and slow components through digital filtering. The server aligns these features along a common time axis by interpolating or resampling them so that the server can construct a unified feature tensor with a defined shape, for example (time_steps, feature_dimensions). This explicit construction of tensors with consistent dimensionality allows the server to exploit vectorized matrix operations on the accelerator, which improves computational throughput and deterministic timing compared with ad hoc, non-vectorized processing.

The server uses a first learning model to estimate an intended action of the user from the standardized brain-related signals. In one embodiment, the server implements the first learning model as a multilayer neural network comprising at least one convolutional neural network (CNN) block followed by at least one recurrent neural network block such as a long short-term memory (LSTM) block. The server stores weight parameters of the neural network in contiguous memory regions and loads them into accelerator memory. The server performs convolution operations along the time dimension and across channels to extract local temporal-spectral patterns from the EEG, followed by non-linear activation functions and pooling layers that reduce dimensionality. The server then feeds the resulting feature sequences into one or more recurrent layers that perform gated recurrent computations, thereby modeling long-range temporal dependencies in the features. The server applies a final fully connected layer and a softmax function to produce a probability distribution over a discrete set of action classes. The server identifies the action class with the highest probability as the intended action and stores both the class and the probability vector in a log structure.

The server uses a second learning model to estimate an emotional state of the user from both the brain-related signals and the biological signals. In one embodiment, the server implements the second learning model as a multimodal neural network including at least one one-dimensional convolutional block for brain-related features and at least one bidirectional recurrent block (for example, a bidirectional LSTM) for biological features. The server concatenates the outputs of these two feature-extraction paths and feeds the combined vector into a sequence of fully connected layers that output continuous scores between 0 and 1 for several emotional dimensions such as anxiety, tension, fatigue, calmness, and satisfaction. The server compares these scores with threshold values stored in configuration data to assign discrete labels such as “high anxiety” or “low fatigue” to each time segment. By structuring the second learning model as a multimodal network and implementing it with optimized tensor operations on the accelerator, the server improves robustness against noise and missing data as compared to a single-modality, CPU-only implementation.

The server determines motion parameters for the motion support mechanical element based on the estimated intended action and the estimated emotional state. In one embodiment, the server uses a control logic module that combines rule-based conditions with a policy derived from reinforcement learning. The server maintains a parameter table that maps pairs of (action_class, emotional_state) to ranges of motion speed coefficients and assist torque coefficients. The server then refines these coefficients using a policy function that is learned from historical sessions. The server converts the selected coefficients into low-level control parameters such as target joint positions, joint velocity profiles, torque limits, and timing constraints specific to each actuator in the motion support mechanical element. For example, when the intended action is “stand up and start walking” and the anxiety score is above a given threshold, the server sets the motion speed coefficient to a reduced value and increases the assist torque coefficient within safety limits. This adjustment, implemented by numeric calculations in the server, reduces abrupt acceleration commands and lowers the risk of destabilization of the user.

The server transmits the motion parameters to a controller of the motion support mechanical element via a communication protocol such as a message queuing protocol or a persistent socket protocol. The server encodes the motion parameters into command frames that specify target joint trajectories and safety constraints. The motion support mechanical element uses an embedded controller to apply these command frames to motor drivers, thereby physically moving the mechanical joints. This closed-loop integration of server-side numerical control computations and device-side actuator control ensures that the method is directly tied to the control of a physical machine, rather than being limited to abstract data processing.

The server logs record information including the standardized brain-related signals, the derived biological features, the intended action estimates, the emotional state scores and labels, the selected motion parameters, and the responses of the motion support mechanical element. The server stores this record information in a structured data store such as a relational database and binary log files. The server regularly processes this record information using data-frame operations to construct training and evaluation datasets, partitioned by sessions and labeled with performance descriptors such as “high anxiety, safe completion” or “high anxiety, aborted action”. By structuring the stored data in this way, the server enables efficient batch retrieval and mini-batch sampling for subsequent training runs, which improves cache utilization and training throughput.

The server updates the first learning model and the second learning model through a learning process executed on the server hardware. In one embodiment, the server defines a loss function for the first learning model as a cross-entropy loss between the predicted action probabilities and ground truth action labels derived from supervisory signals. For the second learning model, the server uses a combination of regression losses (for continuous emotional scores) and classification losses (for emotional labels). The server uses an optimization algorithm such as stochastic gradient descent with momentum or an adaptive optimizer to update the model weights. The server computes gradients using backpropagation and performs weight updates on the accelerator to reduce training time. The server may also apply data augmentation strategies such as additive noise, time-warping of signals, or channel dropout to improve generalization and to make the neural networks more robust to sensor artifacts. These learning procedures are executed periodically or on demand, allowing the models to adapt to new users and conditions over time without manual retuning.

The server further uses a generative AI model as a meta-optimizer of control logic and learning algorithms. The server composes a prompt sentence in natural language by combining statistics derived from the record information, the current intended action, the current emotional state, and user evaluation indices such as post-session ratings. The server prepares the prompt sentence in text form, for example as follows:

“User's intended action is ‘stand up+start walking’, and the emotion engine estimated anxiety=0.82 and tension=0.65. In this system's exoskeleton device, we want to enhance user comfort by adjusting the walking speed coefficient v_coeff and the assist torque coefficient torque_coeff. In past logs, when anxiety was ≥0.8 and v_coeff was set between 0.3 and 0.5 and torque_coeff between 1.2 and 1.4, users tended to report relatively higher calmness and satisfaction. Based on this information, please propose recommended values for v_coeff and torque_coeff for the current state, and explain the rationale.”

The server uses an HTTP client library to transmit this prompt sentence as a request to an external or internal generative AI model implemented as a large language model or similar generative model. The server receives a text response that contains explicit numeric suggestions for control parameters and structured proposals for modifying control rules or learning configurations. The server parses the response using deterministic parsing rules or pattern matching to extract candidate values and rules. The server then validates the extracted candidates against safety constraints and consistency rules stored in configuration data, and, when the candidates pass validation, the server integrates them into the control logic module or the training configuration. For example, the server may adjust the search range of motion speed coefficients used in the reinforcement learning policy or modify the reward function by adding a penalty term for rapid changes in anxiety-related signals. This interaction is not a simple human-like manual analysis but a machine-mediated meta-optimization process in which the server orchestrates prompt generation, model invocation, response parsing, and configuration updates. The use of a standardized prompt sentence structure and a deterministic parsing step makes the integration of generative suggestions into the computational pipeline repeatable and automatable.

The server also uses similar prompt sentences to obtain design proposals for reinforcement learning algorithms. For example, the server may send the following prompt sentence:

“Using a dataset composed of emotion scores estimated from EEG and biological signals, exoskeleton control parameters, and user subjective evaluations (calmness and satisfaction survey scores), propose the design of a reinforcement learning algorithm to learn a control policy that maximizes user calmness. Suggest candidate designs for the state space, action space, and reward function, and discuss how to optimize them.”

The server receives and analyzes the generative AI model's proposals, extracts specific elements such as additional state variables (for example including the rate of change of anxiety), candidate action discretizations (for example discrete levels of torque scaling), or alternative reward functions (for example weighted sums of calmness improvement and motion smoothness). The server uses these extracted elements to instantiate or modify reinforcement learning algorithms, for example by defining new state vectors, altering exploration strategies, or changing reward weights. By doing so, the server systematically improves the internal configuration of learning processes using machine-generated proposals, which would be difficult to derive manually.

The terminal displays information from the server to the user using a graphical user interface. The terminal receives metadata including the estimated intended action, the emotional state, the current control mode, and safety warnings. The terminal parses these values and presents them as text messages such as “Assisting standing up” or “Speed reduced due to high anxiety level”, as icons indicating current mode, and as progress indicators. The user observes these indicators and may provide explicit input, for example by pressing a stop button in the user interface. The terminal transmits such events immediately to the server, which interprets them as emergency stop requests and sends appropriate stop commands to the motion support mechanical element. This interactive loop, in which the terminal mediates between the user and the server, contributes to safe operation of the mechanical system.

The described architecture improves computer technology in several ways. The server organizes multi-modal physiological data into unified tensors and processes them with specialized neural network architectures optimized for vectorized acceleration, which reduces processing latency and increases inference throughput for real-time control. The joint use of brain-related and biological signals, along with the specific model architectures, improves inference accuracy for intended actions and emotional states as compared to simple threshold-based or single-modality systems. The structured logging and use of record information for continuous model updates improve data management and learning efficiency, allowing the system to adapt to different users and scenarios without manual retuning. The integration of a generative AI model through prompt sentences, deterministic parsing, and configuration updates turns the generative model into a system-level optimizer rather than a mere content generator, thereby improving the speed and quality with which the server can explore alternative control and learning strategies. These improvements arise from specific data structures, algorithmic flows, and model configurations executed on general-purpose hardware and accelerators, not from a mere automation of mental steps.

In alternative embodiments, the server may replace the CNN-LSTM structure of the first learning model with other sequence models such as temporal convolutional networks or transformer-based architectures, provided that the server still performs explicit feature extraction and temporal modeling on the brain-related signals. The server may also implement the second learning model using different multimodal fusion strategies, such as attention-based fusion across modalities. The motion support mechanical element may be a lower-limb exoskeleton, an upper-limb orthosis, a trunk support device, or a combination thereof. The terminal may be any computing device capable of executing the described local signal processing and communication functions. Regardless of these variations, the server, the terminal, and the user cooperate such that the server performs specific numerical processing and control computations based on multi-modal physiological data and generative AI model guidance, and the motion support mechanical element executes corresponding physical movements in the real world.

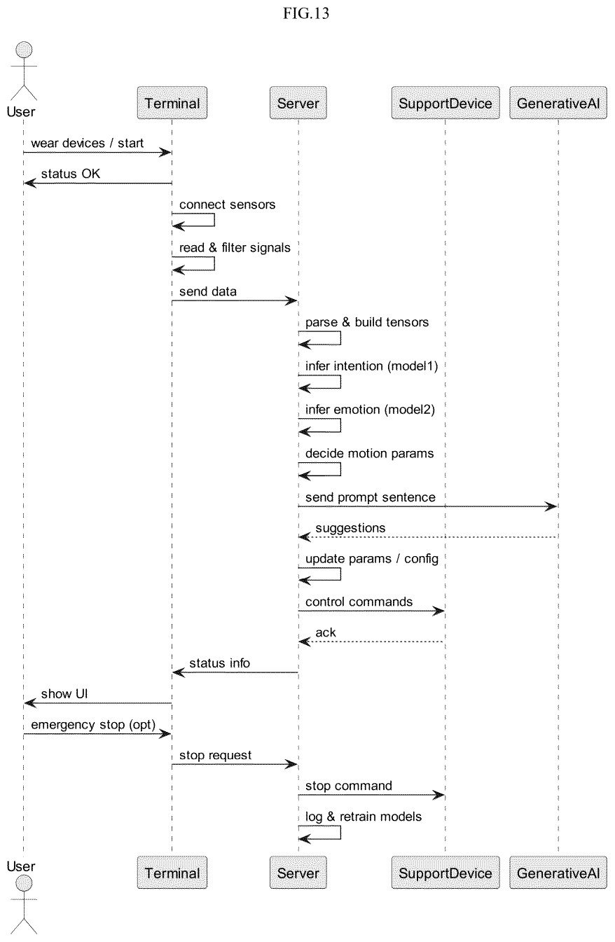

The following describes the processing flow using FIG. 13.

### Step 1:

The user wears the electrical signal measurement devices and the motion support mechanical element.

The input is the physical hardware including an EEG-type brain signal device, biological signal sensors, and a motion support mechanical element. The output is a state in which these devices are correctly attached to the user's body and ready for data acquisition and control. The user places the EEG headset on the head, adjusts electrode positions until contact indicators show acceptable impedance, fastens a heart-rate sensor on the chest and a skin conductance sensor on the skin, and straps the exoskeleton or robotic limb onto the limbs, aligning mechanical joints with anatomical joints. The user operates the terminal to confirm that all devices are recognized and to start a session.

### Step 2:

The terminal establishes wireless connections to the electrical signal measurement devices.

The input is device identification information (for example, Bluetooth addresses) and pairing settings stored on the terminal. The output is active wireless connections and live data streams from the EEG device and biological sensors. The terminal uses a Bluetooth communication stack to scan for the devices, sends pairing and connection requests, and performs handshakes and authentication. The terminal then sends “start measurement” commands via the device-specific software development kits and begins receiving time-stamped EEG samples, heart-beat related samples, and skin conductance samples, placing each packet into a device-specific ring buffer in memory.

### Step 3:

The terminal performs local digital signal processing on the streaming signals.

The input is raw time-series data from the ring buffers, including multichannel EEG samples and biological signal samples with timestamps. The output is preprocessed signal segments in array form, aligned in time and cleaned of noise. The terminal periodically reads fixed-length windows of EEG and biological signals, applies a band-pass filter (for example 0.5-40 Hz) and a notch filter (for example 50 or 60 Hz) using a digital signal processing library, and removes artifacts such as spikes and baseline drift from the heart-rate and skin conductance signals by applying moving-average and high-pass filters. The terminal resamples or interpolates the signals so that they share a common sampling grid and stores the resulting arrays in a temporary buffer.

### Step 4:

The terminal creates structured data objects and transmits them to the server.

The input is the preprocessed and time-aligned signal arrays, along with user identification and device metadata. The output is a serialized data object sent to the server over a network. The terminal encapsulates the arrays into a structured object (for example a JSON-like structure) containing fields for EEG channels, biological features, timestamps, and identifiers. The terminal then opens an HTTPS connection to a server endpoint, serializes the structured object into the request body, attaches authentication headers, and sends the request. The terminal receives the server's response status and logs success or error codes.

### Step 5:

The server parses incoming data and constructs unified tensors.

The input is the serialized structured data object received via the network interface. The output is one or more unified numerical tensors stored in main memory, suitable as input to learning models. The server deserializes the object into in-memory arrays using a parsing library, converts the arrays into multidimensional numerical arrays, and checks for missing or out-of-range values. The server computes channel-wise mean and standard deviation for each EEG channel over a calibration window, then performs standardization by subtracting the mean and dividing by the standard deviation for each value. The server computes biological features such as inter-beat intervals and heart rate variability indices from heart-related signals, and phasic response amplitude and slope from skin conductance signals. The server aligns these features in time and concatenates them with EEG-derived features to form tensors with a fixed shape, for example (time_steps, feature_dimensions).

### Step 6:

The server uses the first learning model to estimate the user's intended action.

The input is the EEG-related portion of the unified tensor representing a recent time window of brain-related activity. The output is a probability distribution over action classes and a selected intended action class. The server loads the tensor into accelerator memory and runs a convolutional neural network followed by a recurrent network. The server performs convolution operations along time and across channels, applies non-linear activation functions, and reduces dimensionality with pooling layers. The server then processes the feature sequence with recurrent layers such as long short-term memory units to model temporal dependencies. The server applies a fully connected layer and softmax function to obtain a probability vector over defined actions (for example “stand up”, “start walking”, “stand up+start walking”, “lift object”). The server selects the class with the maximum probability as the intended action and stores this together with the probability vector in a log record.

### Step 7:

The server uses the second learning model to estimate the user's emotional state.

The input is the combined feature tensor including EEG features and biological features over a corresponding time window. The output is a set of emotional state scores and one or more emotional labels. The server feeds EEG features into one or more one-dimensional convolutional layers to extract local temporal patterns and feeds biological features into at least one bidirectional recurrent layer to capture forward and backward temporal dynamics. The server concatenates the outputs and passes them through fully connected layers that output continuous scores between 0 and 1 for emotional dimensions such as anxiety, tension, fatigue, calmness, and satisfaction. The server compares these scores to threshold values and assigns labels like “high anxiety” when a score exceeds its corresponding threshold. The server logs the scores and labels with timestamps.

### Step 8:

The server determines motion parameters for the motion support mechanical element.

The input is the intended action class, the emotional state scores and labels, and device constraints stored in configuration data. The output is a motion parameter set specifying numerical values for speed, torque, and other control variables. The server queries a control logic module implemented in software, which contains mappings from action-emotion pairs to parameter ranges and may also use a reinforcement learning policy function. The server computes specific values for motion speed coefficients, assist torque coefficients, joint target trajectories, and safety-related limits by evaluating rules and policy outputs, performing arithmetic operations such as scaling and clamping to allowed ranges. The server stores the resulting motion parameters in a structured record and marks them for command generation.

### Step 9:

The server generates a prompt sentence and consults the generative AI model.

The input is record information including current and past intended actions, emotional states, motion parameters, and user evaluation indices, as well as a control objective such as maximizing comfort. The output is an improvement proposal for control logic or learning configuration received as text from the generative AI model. The server computes summary statistics from the record information, such as frequency of high-anxiety sessions and ranges of parameters correlated with high satisfaction, and merges these with the current state into a natural language prompt sentence. The server constructs a text, for example:

“User's intended action is ‘stand up+start walking’, and the emotion engine estimated anxiety=0.82 and tension=0.65. In this system's exoskeleton device, we want to enhance user comfort by adjusting the walking speed coefficient v_coeff and the assist torque coefficient torque_coeff. In past logs, when anxiety was ≥0.8 and v_coeff was set between 0.3 and 0.5 and torque_coeff between 1.2 and 1.4, users tended to report relatively higher calmness and satisfaction. Based on this information, please propose recommended values for v_coeff and torque_coeff for the current state, and explain the rationale.”

The server sends this prompt sentence via an HTTP client to a generative AI model endpoint and waits for the textual response.

### Step 10:

The server parses the generative AI model's response and integrates recommended changes.

The input is the textual response containing recommended parameter values and proposed control or learning adjustments. The output is updated motion parameters and/or updated configuration of control and learning processes. The server applies pattern matching or parsing rules to extract numeric suggestions (for example “v_coeff=0.35”, “torque_coeff=1.35”) and structural advice (for example “reduce acceleration during initial steps”). The server validates extracted values against device safety constraints and internal consistency checks. Once validated, the server modifies the motion parameter record or the configuration of the control logic module, for example by updating default ranges or policy weighting factors. The server logs both the prompt sentence and the generative AI response to maintain traceability.

### Step 11:

The server generates device-specific command frames and sends them to the motion support mechanical element.

The input is the final motion parameter set selected for the current control cycle. The output is one or more command frames transmitted to the motion support mechanical element's controller. The server converts parameters such as speed coefficients and torque coefficients into low-level commands specifying joint target positions, velocities, torque limits, and timing durations. The server encodes these values into a binary or textual frame according to the device protocol and uses a communication client to send the frames over a message channel or persistent socket. The server waits for acknowledgments from the device and, if necessary, retries or switches to a fallback safe command set.

### Step 12:

The terminal receives status information from the server and presents feedback to the user.

The input is status metadata sent from the server, including the intended action, emotional state, applied control mode, and safety state. The output is an updated graphical display on the terminal. The terminal parses the incoming messages and constructs user-friendly strings such as “Assisting standing up” and “Speed reduced due to high anxiety level”, as well as corresponding icons or progress bars. The terminal updates the user interface components and, if applicable, enables or highlights a stop button to allow the user to intervene.

### Step 13:

The user experiences the assisted motion and may issue control inputs via the terminal.

The input is the physical motion produced by the motion support mechanical element and the visual feedback displayed on the terminal. The output is the user's physical response (for example adjusting posture) and any explicit control input such as pressing a stop or pause button. The user feels the exoskeleton or robotic limb move according to the server's commands, and monitors the terminal display to confirm the current assistance phase. If the user senses discomfort or fear, the user presses the emergency stop button. The terminal captures this event and sends an immediate stop request to the server, which then issues an emergency stop command to the motion support mechanical element.

### Step 14:

The server logs session data and updates learning models.

The input is the continuous stream of record information accumulated during the session, including signals, model outputs, motion parameters, device responses, and user actions. The output is updated learning model parameters and updated configuration of reinforcement learning policies. The server writes detailed logs into a database and file storage, then periodically reads these logs to construct structured training datasets. The server computes loss functions comparing model predictions to ground truth labels or evaluation metrics, computes gradients via backpropagation, and applies weight updates to the first and second learning models. For reinforcement learning, the server computes rewards based on combinations of user calmness, motion smoothness, and task success, and updates policy parameters using a selected algorithm. The server may also generate new prompt sentences describing dataset properties and training performance, send them to the generative AI model to obtain algorithmic improvement proposals, and integrate validated changes into the learning configuration.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional body-movement assist systems that rely on brain signal analysis and robotic actuators suffer from several limitations in terms of computer technology. First, known systems typically estimate only a user's motor intention from brain signals or limited physiological signals by using a fixed machine learning model deployed on a server or controller. These systems do not jointly model the user's emotional state, such as anxiety, fear, fatigue, or loss of motivation, and therefore cannot dynamically adapt assist parameters such as assist force, motion pattern, and motion speed in a way that optimally balances safety and comfort. As a result, the underlying inference pipeline and control logic are statically designed and often tuned by manual trial and error, which leads to suboptimal performance, poor scalability, and an increased risk of unsafe or psychologically uncomfortable assistance.

Second, existing computer systems for brain-signal-based assistance mainly operate on a single modality, such as electroencephalographic signals, and do not effectively integrate heterogeneous data types including biological signals, facial expressions, and voice features. This causes the neural network architectures and feature fusion mechanisms implemented in the processor to be underutilized, resulting in lower robustness to noise, reduced estimation accuracy, and degraded reliability of the inference pipeline implemented in software and hardware resources.

Third, conventional systems do not provide a mechanism by which the internal models and logic of the system can be continuously redesigned and updated in an automated or semi-automated manner. In particular, the structure of the action intention estimation model, the structure of the emotional state estimation model, and the parameters of the emotional engine are typically fixed at design time. Any improvement of these components requires engineering experts to manually adjust network architectures, hyperparameters, and rule sets. This lack of adaptive model design leads to a computer system that does not improve over time based on accumulated usage history, thereby limiting the long-term efficiency, maintainability, and adaptability of the software stack.

Fourth, in many existing robotic assist systems, guidance information presented to the user is predefined and static, and does not reflect the current output of the inference pipeline, such as the combined action intention and emotional state. The generation of guidance messages is often separated from the main control logic and is not integrated with the data processing and learning mechanisms on the server. This separation prevents the processor from leveraging advanced generative models in a closed feedback loop, and leads to a poor user interface layer in which the guidance cannot be automatically optimized with respect to safety, clarity, and psychological reassurance.

Therefore, there is a need for a computer-implemented system in which a processor executes a coordinated sequence of operations that: (i) acquires and preprocesses multimodal signals; (ii) jointly estimates action intention and emotional state using deep learning models; (iii) determines personalized assist parameters through a combination of rule-based inference and reinforcement learning; (iv) interacts with a generative AI model via prompt sentences to automatically design and update internal models and guidance logic; and (v) generates context-appropriate guidance information. Such a system should improve the technical performance of the computer platform itself, including robustness of inference, adaptability of model structures, and efficiency of development and maintenance by using generative AI models as part of the runtime optimization loop.

The specific processing by the specific processing unit 290 of the data processing device 12 in Application Example 2 is realized by the following means.

The present invention provides a server comprising a processor configured to acquire multimodal data including brain signal data, biological signal data, image data, and acoustic data of a subject from a plurality of sensing units via a terminal device; to perform preprocessing on the acquired data to generate time-aligned multimodal data and to store the multimodal data in a storage device; to execute an action intention estimation process by applying a deep learning model including a convolution operation layer and a time-series operation layer to the time-aligned multimodal data to output an action intention class of the subject; to execute an emotional state estimation process by applying a deep learning model including an integration layer with an attention mechanism that integrates physiological features, expression features, and voice features derived from the time-aligned multimodal data to output an emotional state class and an emotional intensity of the subject; to execute an emotional engine process by determining initial assist parameters including an assist level, a motion pattern, and a motion speed based on the action intention class and the emotional state class using a rule-based inference unit, and by refining the assist parameters using a reinforcement learning model based on the initial assist parameters and history information stored in the storage device; to generate control commands for at least one robot apparatus including a wearable drive mechanism and a mobile drive mechanism in accordance with the refined assist parameters, and to transmit the control commands to the terminal device for controlling the robot apparatus; to generate and transmit a prompt sentence written in natural language to a generative AI model, the prompt sentence including information relating to at least one of the action intention estimation process, the emotional state estimation process, an assist control policy, and a guidance information generation policy; to receive, from the generative AI model, output information including at least one of a text, a control algorithm proposal, and a model configuration proposal, and to design or update at least a part of a structure or a parameter of at least one of the action intention estimation process, the emotional state estimation process, the emotional engine process, and a guidance presentation logic based on the output information; to receive, from the generative AI model, guidance information corresponding to the action intention class, the emotional state class, and the refined assist parameters, and to transmit the guidance information to the terminal device for presentation to the subject as at least one of voice information and display information; and to record, in the storage device, history information including the action intention class, the emotional state class, the refined assist parameters, and a movement result, and to update parameters of the deep learning models and the reinforcement learning model based on the history information. This enables improvement of the computer system's technical performance by providing a unified processing architecture in which multimodal inference, adaptive control, and generative-model-based design updates are executed in an integrated feedback loop, thereby enhancing robustness and accuracy of intention and emotion estimation, optimizing assist control policies over time, and automatically generating context-aware guidance information without requiring manual redesign of models and rule sets.

The term “brain signal data” refers to digital data representing electrical activity of a subject's brain acquired from one or more electrodes, including time-series measurements such as electroencephalographic waveforms sampled at a predetermined frequency. The term “biological signal data” refers to digital data representing physiological parameters of a subject's body state, including at least one of heart rate, heart rate variability, electrocardiogramals, muscle activity, skin conductance, respiration, and body temperature, measured by one or more biosensors.

The term “image data” refers to digital data representing a visual scene including at least a facial region of a subject, the data including at least one of raw image frames, feature maps, facial landmark coordinates, and numerical expression feature vectors extracted from captured images.

The term “acoustic data” refers to digital data representing sound signals associated with a subject, including at least one of speech waveforms, breathing sounds, and derived acoustic features such as spectral coefficients, pitch, intensity, and speaking rate. The term “multimodal data” refers to a set of time-aligned digital data that combines at least two different types of data among brain signal data, biological signal data, image data, and acoustic data for a common time interval.

The term “terminal device” refers to an information processing device including at least one processor, memory, communication interface, and input/output interface, configured to acquire data from sensing units, perform at least part of preprocessing of the data, and transmit the preprocessed data and control-related information to a server.

The term “information processing apparatus” refers to a computing system including at least one processor, memory, a storage device, and a communication interface, configured to execute software modules for data preprocessing, model inference, control computation, interaction with a generative AI model, and data management.

The term “action intention” refers to conceptual information indicating a type of body movement that a subject internally plans or intends to perform, including classes such as standing up, sitting down, walking, or remaining still.

The term “emotional state” refers to a psychological or affective condition of a subject at a given time, represented as at least one of categorical labels such as safety, anxiety, fear, fatigue, low motivation, or elevation, and numerical intensity values associated with these labels.

The term “action intention estimation process” refers to a computational process executed by a processor to infer an action intention of a subject from input data by applying at least one learned model that receives multimodal data or features derived therefrom and outputs an action intention class and, optionally, a confidence score.

The term “emotional state estimation process” refers to a computational process executed by a processor to infer an emotional state of a subject from input data by applying at least one learned model that receives physiological features, expression features, and voice features and outputs at least one emotional state class and an associated intensity value.

The term “assist parameter” refers to a control parameter set for a robot apparatus assisting a subject's body movement, including at least an assist level indicating a magnitude of support force or torque, a motion pattern indicating a trajectory or sequence of movements, and a motion speed indicating a temporal progression speed of the motion.

The term “assist level” refers to a scalar or vector quantity defining a magnitude of mechanical assistance applied to a subject by a wearable drive mechanism or a mobile drive mechanism, including at least one of force, torque, support force, or intervention degree.

The term “motion pattern” refers to information defining a specific sequence or structure of movements executed by a robot apparatus, including at least one of a joint trajectory, posture transition order, motion mode, and control sequence.

The term “motion speed” refers to information defining a temporal rate at which an assist motion is executed, including at least one of total duration, velocity profile, and acceleration profile of the movement.

The term “emotional engine process” refers to a computational process executed by a processor to determine assist parameters based on at least an action intention, an emotional state, and history information by combining at least a rule-based inference unit and a reinforcement learning model.

The term “rule-based inference unit” refers to a software or hardware component that applies predetermined conditional rules to input information such as action intention, emotional state, and history information, in order to output initial assist parameters that satisfy predefined safety and comfort constraints.

The term “reinforcement learning model” refers to a machine learning model trained with a reinforcement learning algorithm, the model taking as input a state vector including at least an action intention, an emotional state, and history information, and outputting adjustments to assist parameters in order to maximize a cumulative reward associated with safety, performance, and user satisfaction.

The term “robot apparatus” refers to a physical device including at least one actuator and a control unit, configured to assist or support a subject's body movement, the device including at least one of a wearable drive mechanism and a mobile drive mechanism.

The term “wearable drive mechanism” refers to a mechanical structure configured to be attached to at least a part of a subject's body and including one or more actuators, joints, and sensors, the mechanism being controllable to apply forces or torques that assist the subject's body movement.

The term “mobile drive mechanism” refers to a mechanical structure including at least one locomotion module such as wheels, tracks, or legs, and configured to move relative to a surface or environment, to support or assist a subject's movement or posture.

The term “control command” refers to digital data transmitted to a robot apparatus and specifying at least one of target torque, target position, target velocity, trajectory, or operational mode for actuators of the robot apparatus.

The term “generative AI model” refers to a machine learning model that receives as input a natural language prompt or equivalent formatted instruction and generates as output at least one of text, code, network architecture proposals, control algorithm proposals, and guidance text proposals, the model being parameterized by a large number of learned parameters.

The term “prompt sentence” refers to an instruction sequence expressed in natural language or a similar textual format, transmitted from a processor to a generative AI model, and including at least one request relating to action intention estimation, emotional state estimation, assist control policy, model configuration, or guidance information generation.

The term “guidance information” refers to information intended to assist a subject in safely and comfortably performing a body movement, including at least one of textual instructions, spoken messages, graphical symbols, and animation descriptions generated or selected based on current system state.

The term “guidance presentation logic” refers to a set of rules, models, or algorithms executed by a processor to select, structure, and schedule guidance information to be presented to a subject in response to an action intention, an emotional state, and assist parameters.

The term “history information” refers to data recorded over time by a system and associated with a subject, the data including at least action intention classes, emotional state classes, assist parameters, movement outcomes, safety events, and subjective or objective evaluation values.

The term “learned model” refers to a parametric function implemented as software or hardware that has been trained on data to perform a specific task, such as classification or regression, and includes at least one type of deep learning model or reinforcement learning model.

The term “deep learning model” refers to a machine learning model including multiple layers of nonlinear processing units, such as convolution layers, recurrent layers, and attention layers, configured to learn hierarchical representations from input data.

The term “integration layer with an attention mechanism” refers to a neural network component that receives a plurality of feature vectors from different modalities and applies an attention operation to weigh and integrate the feature vectors into a combined representation that emphasizes informative signals.

The term “time-series operation layer” refers to a neural network layer configured to process sequential data, including at least one of a recurrent layer, a gated recurrent unit layer, a long short-term memory layer, or a temporal convolution layer.

The term “storage device” refers to a non-transitory computer-readable medium such as a semiconductor memory, magnetic disk, or optical disk, configured to store data including multimodal data, model parameters, and history information.

The term “processor” refers to one or more computing units, including at least one central processing unit, graphics processing unit, or specialized accelerator, configured to execute sequences of instructions for performing data acquisition, preprocessing, model inference, control computation, interaction with generative AI models, and data storage operations.

In the following embodiments, a server, a terminal, and a user cooperate to implement the claimed system. Each embodiment is described with concrete hardware and software configurations, specific data structures, and algorithmic flows so that a person skilled in the art can implement the invention without undue experimentation.

### A. Overall Configuration of Hardware and Software

The server is an information processing apparatus including at least one central processing unit, at least one memory, at least one non-transitory storage device, and at least one network interface. The server executes application programs and machine learning frameworks such as a general deep learning framework and a reinforcement learning framework. The server also communicates with a generative AI model via a network API.

The terminal is an information processing device including at least one processor, memory, a communication module, a display, a loudspeaker, a camera, and a microphone. The terminal is equipped with wireless communication capabilities such as a short-range wireless communication standard for connecting to sensors, and a wide-area communication protocol such as an Internet protocol for communicating with the server.

The user wears or contacts multiple sensing units. The sensing units include at least a brain signal sensor mounted on the scalp, a biological signal sensor such as a heart-rate sensor attached to the chest or limb, an image capture device configured to capture a facial region, and an acoustic sensor configured to capture speech and breathing.

The server executes software modules that implement: (i) multimodal data reception and storage; (ii) an action intention estimation process; (iii) an emotional state estimation process; (iv) an emotional engine process including a rule-based inference unit and a reinforcement learning model; (v) robot control command generation; (vi) prompt sentence construction and interaction with a generative AI model; (vii) guidance information generation and selection; and (viii) history recording and model updating.

The terminal executes software modules that implement: (i) acquisition and preprocessing of brain signal data, biological signal data, image data, and acoustic data; (ii) construction and transmission of time-aligned multimodal data; (iii) reception and low-level translation of robot control commands; and (iv) presentation of guidance information as audio and display content to the user.

### B. Multimodal Sensing and Preprocessing

The terminal uses a wireless protocol to establish a connection to a brain signal sensor and a biological signal sensor. The terminal configures the sampling frequency for the brain signal sensor, for example, 256 samples per second, and stores incoming samples in a circular buffer in main memory. The terminal also receives time-stamped intervals between heartbeats from the biological signal sensor, representing R-R interval data.

The terminal uses a general-purpose numerical computation library and a brain signal processing library to perform band-pass filtering on the raw brain signal data. The terminal applies a finite impulse response or infinite impulse response filter with passband limits such as 0.5 Hz and 40 Hz, in order to suppress baseline drift and high-frequency noise. The terminal then executes an independent component analysis routine provided by the brain signal processing library. The terminal decomposes the multichannel brain signal into independent components, identifies components corresponding to ocular artifacts and motion artifacts based on spatial patterns and time-domain statistics, and reconstructs artifact-reduced brain signals by excluding those components. This specific signal processing chain improves the signal-to-noise ratio and reduces error rates in downstream model inference, as compared with simple thresholding.

The terminal calculates heart rate variability indices from the R-R interval data using a biological signal analysis library. The terminal computes time-domain measures such as mean heart rate and root mean square of successive differences, and frequency-domain measures such as low-frequency and high-frequency power ratios by applying a spectral estimation method. The terminal encapsulates these measures into a fixed-length physiological feature vector, which provides a compact representation of autonomic nervous system activity for the server.

The terminal activates the camera to capture image frames of the user's face. The terminal uses a general-purpose image processing library to obtain frames and a facial landmark detection library to compute two-dimensional coordinates of facial landmarks, including eye corners, eyebrows, nose, and mouth. The terminal derives expression features by computing geometric quantities such as distances between mouth corners and distances between eyebrows and eyes, normalized by an inter-pupil distance. These numerical features form a facial feature vector that is robust to lighting variation and reduces the amount of data to be transmitted as compared with raw images, thereby reducing communication load. The terminal continuously acquires acoustic data through the microphone. The terminal segments the continuous audio signal into short overlapping frames with predetermined frame length and frame shift. For each frame, the terminal computes acoustic features such as mel-frequency cepstral coefficients, pitch frequency, log energy, and estimated speaking rate using an audio analysis library. The terminal arranges these acoustic features into an acoustic feature matrix indexed by time.

The terminal then aligns the brain signal features, heart rate variability features, facial feature vectors, and acoustic feature matrices in time. The terminal uses timestamps generated at acquisition to align these modalities into time windows of fixed length, for example, two seconds. For each window, the terminal performs z-score normalization on each feature dimension using mean and standard deviation parameters provided by the server. The terminal groups the normalized features into a multimodal data structure that includes: (i) a brain signal feature matrix; (ii) a biological feature vector; (iii) a facial feature matrix; and (iv) an acoustic feature matrix. This multimodal data structure is serialized into a compact format and transmitted to the server using a secure communication protocol. By executing these steps, the terminal reduces data redundancy, improves consistency across modalities, and decreases the computational load on the server.

### C. Action Intention Estimation Process on the Server

The server receives time-aligned multimodal data from the terminal and stores it in a storage device as a structured record identified by user ID and timestamp. The server executes an action intention estimation model that is implemented as a deep learning model within a machine learning framework.

The server constructs an input tensor for the action intention estimation model from the brain signal feature matrix and optionally the biological feature vector. The server normalizes the input tensor using stored normalization parameters, then feeds the tensor into a neural network architecture comprising at least one convolutional layer followed by at least one time-series processing layer.

In one embodiment, the server uses a one-dimensional convolutional layer that performs convolution operations across the time dimension for each channel, with multiple filters of different kernel sizes. The server applies a nonlinear activation function such as a rectified linear unit and a pooling operation to reduce temporal resolution while preserving distinctive patterns. The convolutional output is then supplied to a long short-term memory layer that processes the temporal sequence and maintains a hidden state representing context over time. The server reads the final hidden state or an aggregation of hidden states and feeds it into a fully connected layer with a softmax output. The softmax output provides a probability distribution over action intention classes including at least standing up, sitting down, walking, and remaining still.

The server calculates a cross-entropy loss function during training using labeled data that pairs multimodal input windows with ground-truth action intention labels. The server updates network weights using a gradient-based optimizer such as stochastic gradient descent with momentum or an adaptive optimizer. The server may perform data augmentation on brain signal data by introducing small temporal shifts or additive noise within a permissible range, to improve generalization. During operation, the server uses the trained model in inference mode and obtains an estimated action intention class and an associated confidence value. This structured model architecture and training method reduces misclassification and improves response speed as compared with manually crafted signal processing pipelines.

### D. Emotional State Estimation Process on the Server

The server constructs an input collection for an emotional state estimation model using brain signal features, biological feature vectors, facial feature matrices, and acoustic feature matrices. The server partitions these inputs into modality-specific branches of a multimodal deep learning architecture.

The server applies a one-dimensional convolutional layer and a bi-directional time-series layer, such as a bi-directional long short-term memory layer, to the brain signal features and biological features. This path extracts temporal physiological representations of, for example, stress-related patterns. The server applies a convolutional neural network to facial features or image embeddings to derive a visual emotion feature vector. The server also applies a pre-trained audio representation model or a stack of convolutional and recurrent layers to the acoustic feature matrices to obtain an acoustic emotion feature vector. The server integrates the modality-specific feature vectors using an integration layer with an attention mechanism. The server arranges the feature vectors as a sequence and applies a multi-head attention mechanism that computes attention scores among the modalities. The attention mechanism computes contextualized representations by weighting each modality according to its relevance, which is particularly beneficial when one modality is noisy or missing. The server combines these contextualized representations into a unified multimodal representation.

The server feeds the unified representation into one or more fully connected layers that output a vector of scores over emotional state classes such as safety, anxiety, fear, fatigue, low motivation, and elevation. The server applies a softmax function to obtain probabilities for each class and further outputs continuous intensity values obtained from one or more regression nodes. The server trains this network using a combination of classification loss and regression loss, such as a weighted sum of cross-entropy and mean squared error. The server updates weights using a gradient-based optimizer and may apply regularization techniques such as dropout to reduce overfitting. The use of multimodal attention-based integration provides improved robustness and accuracy in emotional state estimation compared with simple concatenation of features, thereby improving the reliability of downstream assist control.

### E. Emotional Engine Process and Assist Parameter Determination

The server executes an emotional engine process that uses both a rule-based inference unit and a reinforcement learning model to compute assist parameters. The server first collects an action intention class, an emotional state class and intensity, and history information from storage. The history information may include previous assist parameters, movement success or failure, near-fall occurrences, and user comfort ratings.

The server encodes this information into a fact object and provides it to a rule-based inference unit implemented as a rule engine. The rule engine holds a set of deterministic rules, each comprising a condition part and an action part. For example, one rule may specify that when the action intention is standing up and the emotional state is anxiety with high intensity, the initial assist level should be set to high, the motion speed should be reduced to a fraction of the default speed, and a safety mode flag should be enabled. Another rule may specify that when the action intention is walking, the emotional state is fatigue, and the recent walked distance exceeds a threshold, a short-walk pattern followed by a rest recommendation should be selected.

The server executes the rule engine, which evaluates conditions against the fact object, triggers all applicable rules, and resolves conflicts by a priority scheme. The rule engine outputs initial assist parameters comprising an assist level, a motion pattern, and a motion speed. These rule-based parameters guarantee a conservative, safety-oriented baseline according to explicit, non-human-conventional criteria that are embedded in the computational rules.

The server then refines the assist parameters using a reinforcement learning model. The server represents the current state as a state vector that concatenates encoded action intention, encoded emotional state, physiological indices, and summarized history data. The server inputs this state vector into a policy network or value network implemented in a reinforcement learning framework. In one embodiment, the server uses a deep Q-network comprising multiple fully connected layers with nonlinear activations, or a policy gradient method that directly outputs parameter adjustment values.

The reinforcement learning model outputs adjustment values for the assist level, motion pattern selection parameters, and motion speed. The server applies these adjustments to the initial assist parameters, clamps the results within safe ranges, and obtains refined assist parameters. During training, the server gathers experience tuples including state, action (parameter adjustment), reward, and next state. The reward function may be defined based on movement success, absence of falls, reported comfort, and energy efficiency. The server updates the reinforcement learning model using a temporal-difference error and a gradient-based optimizer. This combination of rule-based and reinforcement learning components allows the computer system to dynamically optimize assist parameters in a manner that human experts cannot easily replicate manually, leading to improved safety and personalization over time.

### F. Robot Control Command Generation and Device Control

The server converts the refined assist parameters into robot control commands suitable for a wearable drive mechanism and/or a mobile drive mechanism. The server accesses device-specific configuration data defining, for each actuator, the relationship between assist level and desired torque or force. For a wearable drive mechanism attached to the lower limbs, the server computes a torque trajectory for joints such as the knee and hip over the duration of the motion pattern. The server uses motion pattern definitions that include joint angle keyframes and timing points to map motion speed into timing parameters.

The server encodes these trajectories and parameters into control commands specifying joint identifiers, target torque or position values, and timestamps or durations. For a mobile drive mechanism, the server computes linear and angular velocity commands derived from motion speed and pattern, and constructs messages conforming to a robot middleware protocol. The server transmits these control commands to the terminal over a network.

The terminal receives the control commands and translates them into low-level communication frames, such as messages for a serial bus or field bus. The terminal transmits these frames to actuator controllers at specified update rates. The controllers then generate electrical signals to drive motors and actuators. This end-to-end flow from multimodal inference to physical actuation demonstrates that the system is tied to concrete machine control and is not limited to abstract information processing.

G. Interaction with Generative AI Model and Prompt Sentences

The server interacts with a generative AI model via an application programming interface exposed by a remote or local service. The server prepares prompt sentences written in natural language that describe current system status and desired outputs. The prompt sentences follow a structured pattern that includes explicit descriptions of input modalities, target tasks, and required output formats.

In one example, the server constructs the following prompt sentence to obtain a multimodal network architecture design:

“Propose a multimodal neural network architecture that takes EEG data, physiological signals, facial images, and audio data as input and simultaneously estimates a subject's action intention and emotional state. Describe preprocessing procedures for each modality, types of feature extraction networks such as convolutional neural networks, recurrent neural networks, and Transformer models, and a final integration method. Provide an implementation-oriented description that can be realized using a general machine learning framework.”

In another example, the server constructs the following prompt sentence to design a reinforcement-learning-based control policy:

“Design a reinforcement-learning-based control policy that dynamically adjusts the assistive force and motion speed of a wearable actuator based on the subject's action intention classes (stand, walk, sit, stay) and emotional state classes (safety, anxiety, fear, fatigue, low motivation, elevation). Specify the state space, action space, reward function, and network structure, and describe an implementation approach using a common machine learning framework.”

In a further example, the server constructs the following prompt sentence to generate user guidance:

“Analyze EEG and physiological information of an elderly user who intends to stand up and is currently feeling strong anxiety. Generate Japanese voice guidance sentences that provide reassurance and specific step-by-step instructions. Create two sentences for each phase: preparation, start of standing up, and completion of standing up. Emphasize safety, slow movements, and calming expressions.”

The server transmits such prompt sentences to the generative AI model and receives text outputs that may include architecture proposals, control algorithm outlines, or candidate guidance sentences. The server parses and evaluates the outputs using rule-based or scoring functions and selectively applies them to update model architectures, hyperparameters, or guidance templates. This interaction is not a simple replacement of human design work; it is tightly integrated into the runtime system, allowing the server to adapt model structures and logic based on ongoing data and performance evaluations. This improves the efficiency of model updates and enables a more agile optimization of the computer system than traditional manual tuning.

### H. History Recording and Model Updating

The server records action intention estimates, emotional state estimates, assist parameters, movement results, and user evaluations in a structured history database. Each record is indexed by user ID and timestamp and includes identifiers for the model versions used. The server periodically initiates batch training jobs that load history data and perform retraining of the action intention model, the emotional state model, and the reinforcement learning model.

The server splits history data into training and validation sets, constructs mini-batches, and executes training loops that compute losses, gradients, and weight updates. The server may apply curriculum learning strategies, in which samples from easier contexts are used earlier and more complex or noisy samples are gradually introduced. This retraining process improves model accuracy and robustness, reduces inference errors, and can be scheduled during off-peak hours to minimize impact on real-time operations.

The server may also consult the generative AI model with a prompt sentence requesting improvements to the training schedule or regularization methods. The server evaluates suggested modifications, such as adjusting learning rates, adding batch normalization layers, or adopting new attention mechanisms, and applies validated changes to the next training cycle. This closed loop of logging, retraining, and model redesign leads to a continuous improvement of the computer system's technical performance.

### I. Technical Effects and Variations

The system achieves multiple technical effects at the computer-technology level. By performing multimodal preprocessing at the terminal and transmitting compact features instead of raw high-volume signals, the system reduces network bandwidth usage and lowers latency between sensing and control. By employing convolutional and time-series neural architectures with attention-based multimodal integration, the system improves the accuracy and robustness of intention and emotion estimates compared to conventional single-modality or rule-only systems. By combining a rule-based engine with a reinforcement learning model in the emotional engine, the system attains adaptive assist control that evolves with user history while maintaining safety constraints, which reduces the risk of falls and unnecessary intervention.

The interaction with a generative AI model through prompt sentences enables automated or semi-automated redesign of model architectures and control policies, which would be difficult to achieve by manual trial and error. This results in reduced development time, faster convergence to effective model structures, and an ability to respond rapidly to new types of users or environments. Because the generative AI outputs are integrated into specific technical modules—such as network architectures, algorithmic rules, and guidance templates—the invention improves the internal operation of the computer system rather than merely automating a human cognitive task.

Alternative embodiments include variations where the brain signal sensor is replaced or supplemented by other neurophysiological sensors, where the robot apparatus consists solely of a mobile drive mechanism or solely of a wearable drive mechanism, or where the emotional state model uses different network types such as graph neural networks for sensor topology representation. The integration layer may use different attention mechanisms or gating functions. The reinforcement learning model may be replaced by other sequential decision-making algorithms such as model-based reinforcement learning, and the reward function may be customized for specific rehabilitation protocols or user populations.

In each embodiment, however, the server, terminal, and user cooperate through the specific multimodal processing, learning, and control architecture described above, thereby ensuring that the invention extends beyond abstract data manipulation and provides concrete technical improvements in sensing, inference, control, and adaptive design of the underlying computer system.

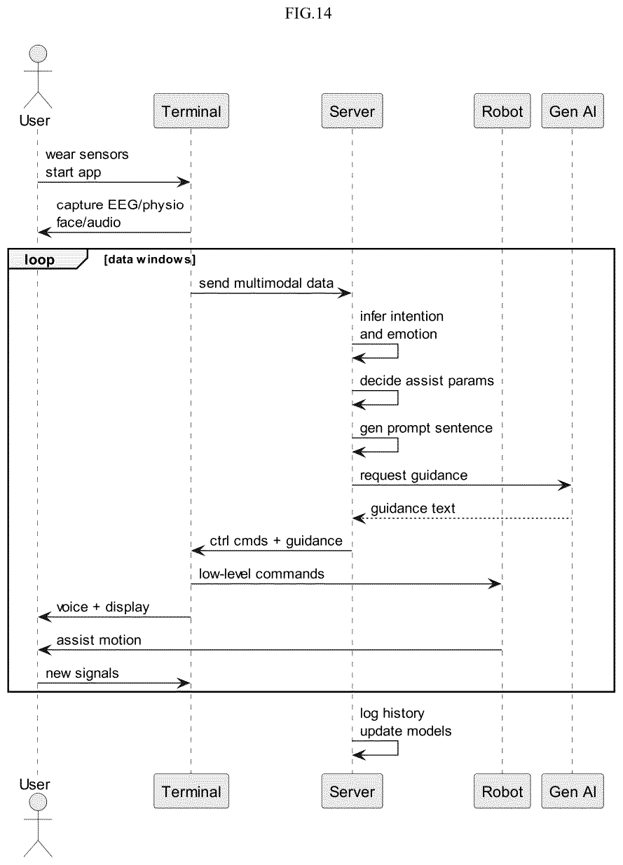

The following describes the processing flow using FIG. 14.

### Step 1:

The user wears sensing units and positions the assist device.

Input: None (user's natural state).

The user attaches a brain signal sensor to the scalp, a biological signal sensor (for example, a heart-rate sensor) to the chest or limb, and, when necessary, a wearable drive mechanism to the legs or positions near a mobile drive mechanism.

Output: The user's internal action intention and emotional state begin to produce physical signals such as brain signals, heart rate changes, facial expressions, and voice, which become observable by the terminal and sensors.

### Step 2:

The terminal establishes wireless connections to the sensing units.

Input: Identification information and communication parameters of the brain signal sensor and biological signal sensor.

The terminal uses a wireless communication protocol to pair with the brain signal sensor and the biological signal sensor, and registers callback functions or data streams for each device. The terminal configures sampling rates and data packet formats through device-specific commands.

Output: Continuous raw brain signal samples and R-R interval events are streamed from the sensing units into memory buffers on the terminal.

### Step 3:

The terminal preprocesses the brain signal data.

Input: Raw multichannel brain signal time-series data from the brain signal sensor.

The terminal applies a band-pass digital filter to each channel to remove components outside a predetermined frequency range and suppress noise. The terminal then executes an independent component analysis algorithm to decompose the filtered data into independent components, identifies artifact components associated with eye movements and body motion based on spatial patterns and variance, and reconstructs cleaned brain signals by excluding those components.

Output: Artifact-reduced brain signal data represented as a multichannel time-series array, suitable for feature extraction.

### Step 4

The terminal computes physiological features from biological signal data.

Input: Time-stamped R-R interval data from the biological signal sensor.

The terminal calculates heart rate variability indices by applying statistical and spectral analysis to the R-R intervals. The terminal computes measures such as mean heart rate, root mean square of successive differences, and low-frequency to high-frequency power ratio using numerical analysis routines.

Output: A physiological feature vector summarizing heart rate variability and related autonomic nervous system activity over a given time window.

### Step 5:

The terminal acquires facial image data and derives facial expression features.

Input: Image frames captured by the camera that include the user's face.

The terminal detects the facial region using an image processing algorithm and estimates facial landmarks such as eye corners, eyebrows, nose, and mouth points using a facial landmark detection model. The terminal then calculates expression-related geometric features, including normalized distances between mouth corners, eyebrow elevation, and eye opening, by processing the landmark coordinates.

Output: A sequence of facial expression feature vectors aligned with frame timestamps.

### Step 6:

The terminal acquires acoustic data and derives voice features.

Input: Continuous audio waveforms captured by the microphone.

The terminal segments the audio into overlapping frames of fixed length and computes acoustic features for each frame using audio signal processing routines. These features include mel-frequency cepstral coefficients, pitch values, log energy, and estimated speaking rate. The terminal arranges these feature vectors in chronological order. Output: A sequence of acoustic feature vectors indexed by time.

### Step 7:

The terminal constructs time-aligned multimodal data windows.

Input: Cleaned brain signal data, physiological feature vectors, facial expression feature vectors, and acoustic feature vectors with timestamps.

The terminal groups these features into fixed-length time windows, for example, two-second intervals, based on their timestamps. The terminal performs z-score normalization on each feature dimension using pre-distributed mean and standard deviation values, and resamples or interpolates features as needed so that each modality aligns to a common temporal grid within each window.

Output: A multimodal data structure for each time window that includes normalized brain signal features, physiological features, facial features, and acoustic features, all time-aligned.

### Step 8:

The terminal serializes and transmits the multimodal data to the server.

Input: Time-aligned multimodal data structures and user identification information.

The terminal serializes each multimodal data structure into a compact message format and establishes a secure communication session with the server using a network protocol with encryption. The terminal transmits each message to a predefined endpoint on the server, handling retransmissions and buffering in case of temporary network issues.

Output: Securely transmitted multimodal data packets arriving at the server for further processing.

### Step 9:

The server receives and stores the multimodal data.

Input: Serialized multimodal data packets from the terminal.

The server verifies the integrity and authenticity of incoming packets, deserializes the packet content into internal data structures, and stores the multimodal data in a storage device together with user IDs and timestamps. The server may enqueue references to the stored data into a processing queue or message broker for subsequent inference tasks.

Output: Accessible multimodal data records prepared as input to the action intention and emotional state estimation processes.

### Step 10:

The server estimates the user's action intention using a deep learning model.

Input: Brain signal feature matrices and, optionally, physiological feature vectors from a selected time window.

The server constructs an input tensor and feeds it into a neural network composed of convolution layers and time-series processing layers. The convolution layers extract temporal patterns within and across channels, and the time-series layers, such as recurrent or temporal convolution layers, model dependencies over time. The server passes the resulting representation through fully connected and softmax layers to compute class probabilities for action intentions.

Output: An action intention class label, such as standing up or walking, and a probability distribution indicating confidence for each possible class.

### Step 11:

The server estimates the user's emotional state using a multimodal deep learning model.

Input: Brain signal features, physiological feature vectors, facial expression feature matrices, and acoustic feature matrices for the same time window.

The server feeds each modality into a dedicated sub-network, such as a temporal network for physiological and brain signals, a convolutional network for facial features, and a temporal or pre-trained audio representation network for acoustic features. The server then processes the resulting feature vectors through an integration layer that uses an attention mechanism to compute modality-weighted representations. Finally, the server passes the integrated representation through output layers that compute a probability distribution over emotional state classes and continuous intensity values.

Output: An emotional state class label, such as anxiety or fatigue, and associated intensity values and class probabilities.

### Step 12:

The server records inference results and composes a state description.

Input: Estimated action intention class and probabilities, estimated emotional state class and intensities, and current time.

The server writes these inference results into a history record stored in the storage device, linked to the corresponding multimodal data window. The server also composes a state vector that encodes these outputs together with recent historical indicators such as past assist parameters and movement outcomes.

Output: A stored history entry and a structured state vector representing the current and recent user state.

### Step 13:

The server determines baseline assist parameters using rule-based inference.

Input: State vector containing action intention, emotional state, and historical indicators.

The server provides the state vector to a rule-based inference module that contains a set of predefined rules. The module evaluates conditions on the state, such as combinations of action intention and emotional state intensity, and triggers corresponding actions that assign initial values for assist level, motion pattern, and motion speed. The server aggregates the outputs of triggered rules according to a priority policy.

Output: Baseline assist parameters specifying an assist level, a motion pattern, and a motion speed that satisfy predefined safety-oriented constraints.

### Step 14:

The server refines assist parameters using a reinforcement learning model.

Input: The baseline assist parameters and the state vector.

The server encodes the state vector and baseline parameters into a numerical input for a reinforcement learning policy network. The server performs a forward pass through the network to obtain adjustment values for the assist level, motion pattern selection, and motion speed. The server adds these adjustment values to the baseline parameters and clamps the results to lie within safe operational ranges.

Output: Refined assist parameters tailored to the individual user's current condition and historical responses.

### Step 15:

The server generates robot control commands based on the refined assist parameters.

Input: Refined assist level, motion pattern, and motion speed.

The server maps the assist level to specific torque or force targets for actuators in the wearable drive mechanism and maps the motion pattern to a sequence of joint trajectories or movement phases with timing determined by the motion speed. For a mobile drive mechanism, the server converts motion pattern and speed into velocity and direction commands. The server encodes these into structured control messages specifying actuator identifiers, target values, timing, and safety flags.

Output: Robot control commands ready to be transmitted to the terminal for execution by the wearable and/or mobile drive mechanisms.

### Step 16:

The server constructs a prompt sentence and queries the generative AI model for guidance.

Input: Estimated action intention, emotional state, refined assist parameters, and safety constraints.

The server assembles a natural language description of the current scenario, including the user's intention, emotional condition, and desired characteristics of guidance such as reassuring tone and step-by-step instructions. The server formulates this description into a prompt sentence, for example:

“Analyze EEG and physiological information of an elderly user who intends to stand up and is currently feeling strong anxiety. Generate Japanese voice guidance sentences that provide reassurance and specific step-by-step instructions. Create two sentences for each phase: preparation, start of standing up, and completion of standing up. Emphasize safety, slow movements, and calming expressions.”

The server sends this prompt sentence to the generative AI model via an API call.

Output: A request to the generative AI model that specifies the context and required format of the guidance sentences.

### Step 17:

The server receives candidate guidance sentences and selects appropriate ones.

Input: Text output from the generative AI model containing multiple candidate guidance sentences.

The server parses the returned text to separate candidate sentences by phase. The server evaluates each candidate using selection criteria, such as whether the sentence contains actionable instructions, uses calming language, and aligns with the refined assist parameters. The server assigns scores to candidates and selects the best sentences for each phase according to the scores.

Output: A set of selected guidance sentences, each associated with a movement phase, ready for presentation to the user.

### Step 18:

The server transmits control commands and guidance information to the terminal.

Input: Robot control commands and selected guidance sentences.

The server packages the control commands and guidance sentences into a message structure with identifiers for the corresponding phases and timing information. The server then sends this message to the terminal over a secure network connection.

Output: A combined control-and-guidance message received by the terminal for local execution and presentation.

### Step 19:

The terminal drives the actuators and presents guidance to the user.

Input: Combined control-and-guidance message from the server.

The terminal extracts low-level control parameters and converts them into hardware-specific control frames for the wearable drive mechanism and/or mobile drive mechanism. The terminal sends these frames to the robot controllers via a communication bus. At the same time, the terminal selects the appropriate guidance sentence for the current phase, converts the text into synthesized speech using a text-to-speech engine, and outputs audio through the loudspeaker. The terminal also displays the text and optional icons on the screen.

Output: Execution of assisted movement by the robot apparatus and synchronized voice and visual guidance presented to the user.

### Step 20:

The user performs the assisted movement while new signals are generated.

Input: Mechanical assistance from the robot apparatus and guidance from the terminal.

The user follows the guidance, performs the intended movement such as standing up or walking, and experiences changes in physical and emotional state. These changes manifest as new brain signal patterns, altered heart rate variability, updated facial expressions, and potential vocal reactions.

Output: Updated sensor signals that reflect the outcome of the assisted movement and that are captured again by the terminal, closing the loop for continuous system operation.

### Step 21:

The server records movement outcomes and updates learning models over time.

Input: Movement result indicators (for example, success, instability, or interruption), user feedback, and logged inference and control data.

The server stores movement outcome labels and any user satisfaction scores together with the previously recorded state vectors and assist parameters. Periodically, the server loads accumulated history data and retrains the action intention model, emotional state model, and reinforcement learning model. The server computes loss functions such as cross-entropy for classification and temporal-difference error for reinforcement learning, updates model weights using optimization algorithms, and deploys updated models for future inferences.

Output: Refined model parameters and improved inference and control performance for subsequent sessions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

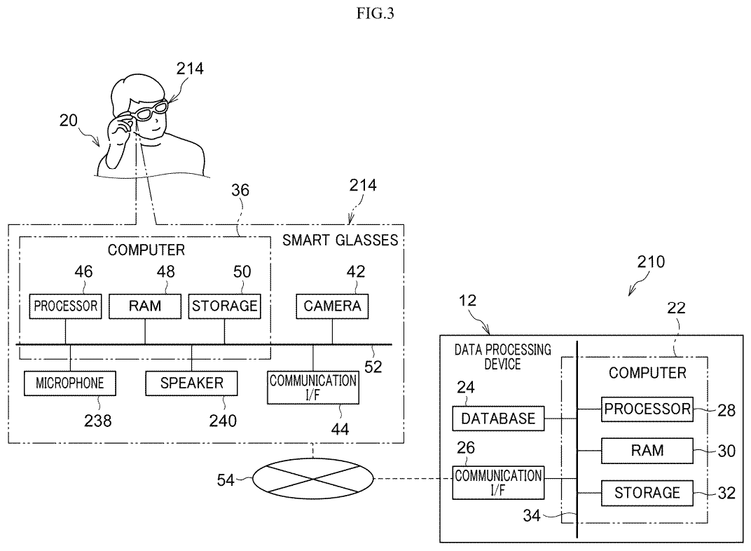

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

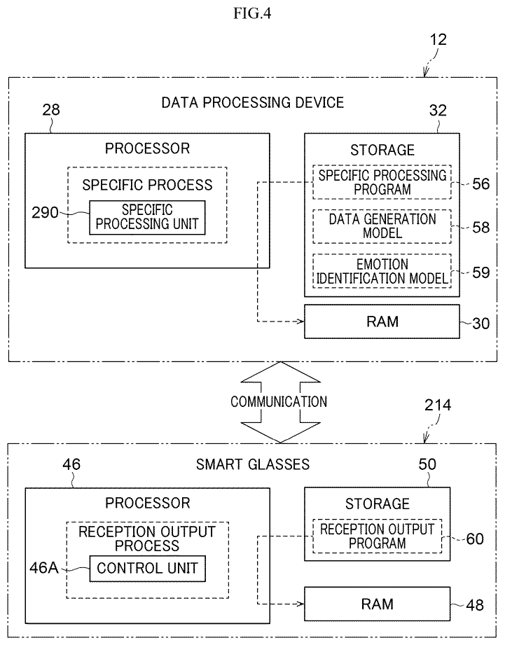

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

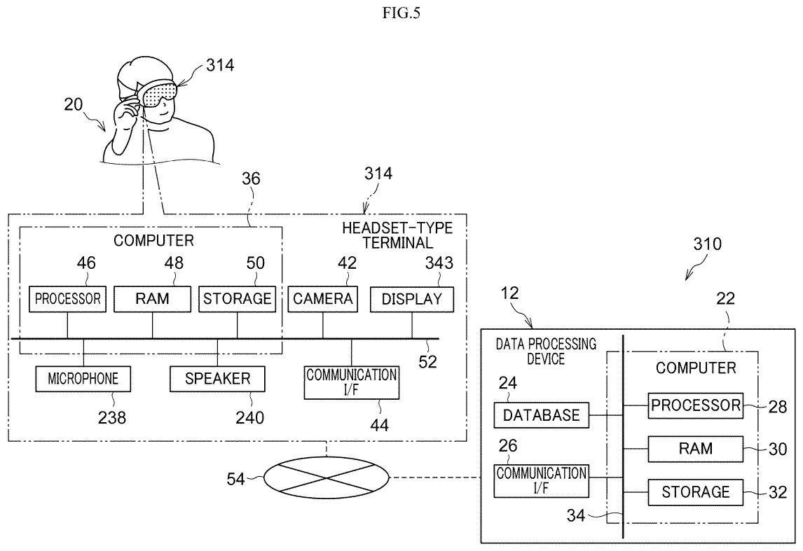

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

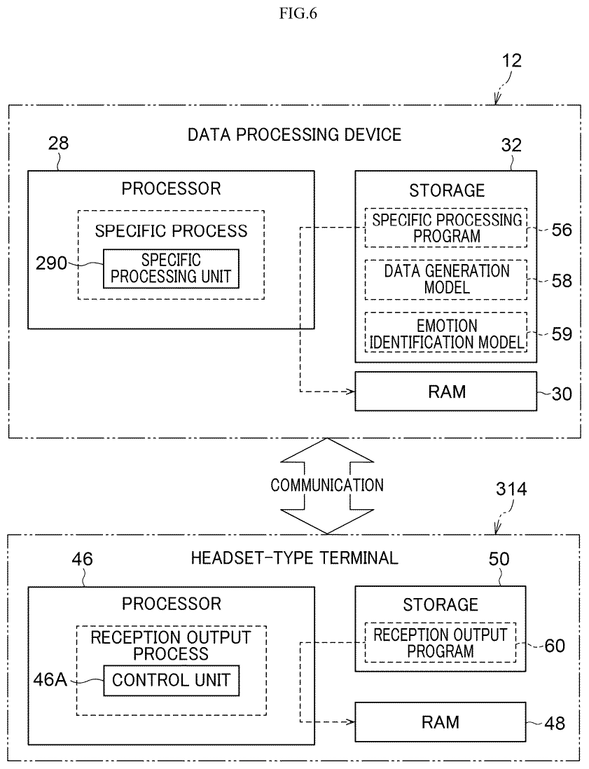

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

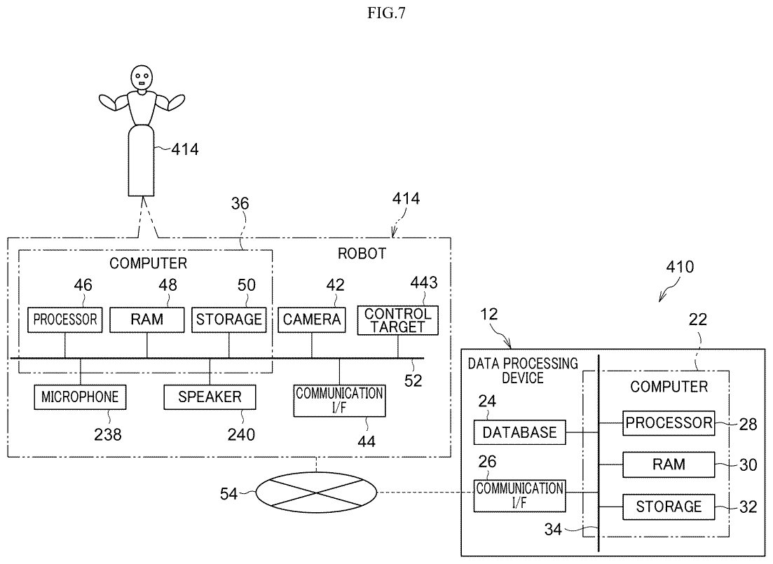

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

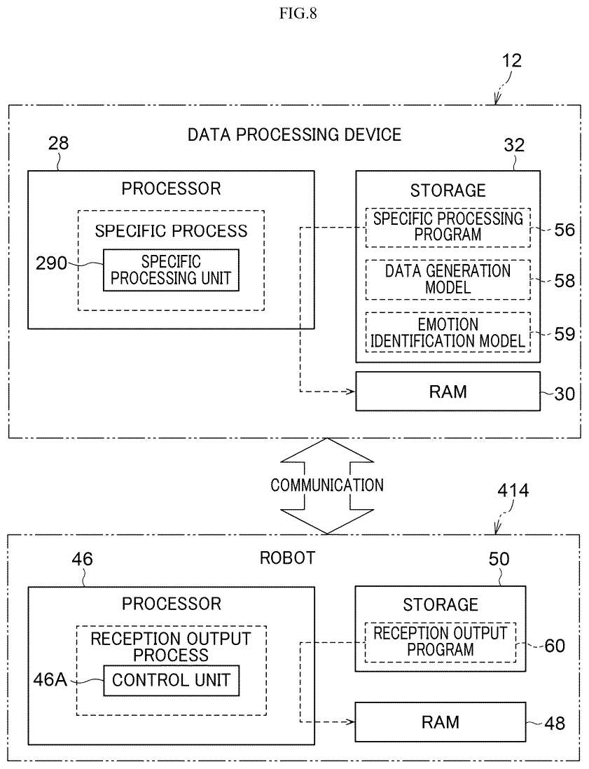

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

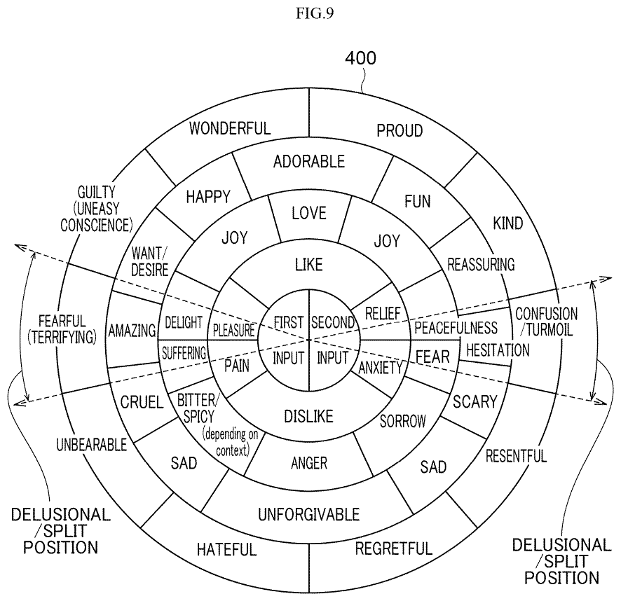

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

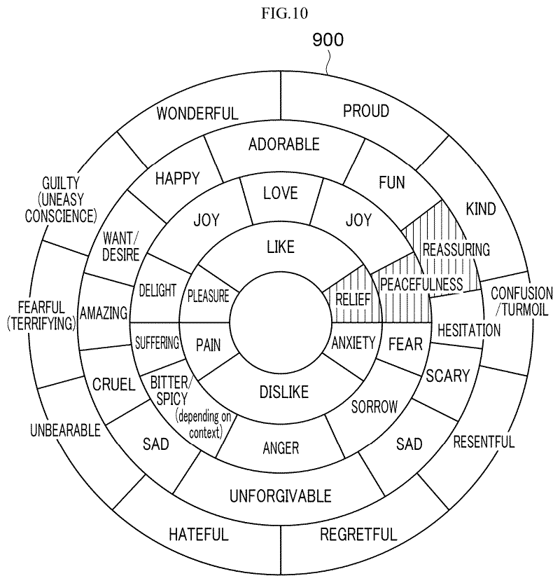

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, via a plurality of electrodes attached to a scalp of a user, bioelectrical signals sampled at a predetermined sampling frequency, convert the bioelectrical signals into digital signals, and transmit the digital signals to a terminal device,
perform, at the terminal device, preprocessing on the digital signals by executing a band-pass filter process that passes only frequency components within a predetermined frequency band and a notch filter process that suppresses power-supply frequency components, configure the preprocessed digital signals into data sets for each signal interval having a predetermined time length, and transmit the data sets to a server via an encrypted communication path,
store, at the server, the data sets as time-series data in a storage medium, convert the time-series data into tensor data by numerical computation, and classify the time-series data using a trained information processing model that includes a computation layer configured to extract spatial and frequency features by convolution computation and a computation layer configured to analyze temporal transitions of the features by recurrent computation, thereby outputting intention information corresponding to a predetermined action of the user,
generate, at the server, high-level motion command data including at least a motion type, a motion target body part, and an assistance intensity based on the intention information, and transmit the high-level motion command data to the terminal device,
receive, at the terminal device, the high-level motion command data, convert the high-level motion command data into low-level control command data corresponding to an actuated mechanism, and transmit the low-level control command data to a robot mechanism via a local communication path,
control, by the robot mechanism worn on a body of the user and including a multi-joint drive mechanism and a sensor configured to detect at least one of a joint angle, an acceleration, a force, and a torque of the multi-joint drive mechanism, the multi-joint drive mechanism so as to generate a predefined joint trajectory based on the low-level control command data, and execute feedback control computation at a predetermined cycle so as to correct a drive output in accordance with a difference between a detection value from the sensor and the joint trajectory, thereby assisting a body motion of the user, and
record, at the server, the time-series data, the intention information, the high-level motion command data, and information on an execution result of the assisting of the body motion in association with one another, perform relearning of the trained information processing model based on the record so as to update model parameters for each user, and reflect an updated model in inference processing as an adaptive learning process.

### (Supplementary 2)

The system according to supplementary 1,
wherein the processor is configured to
execute, at the server, a generative design process in which a generative AI model receives at least one prompt sentence indicating a structure of the trained information processing model, conditions of the band-pass filter process and the notch filter process, a format of the high-level motion command data, and a control rule of the feedback control computation, and automatically generates or improves at least a part of the trained information processing model and a control algorithm of the multi-joint drive mechanism, and to cooperate the generative design process with the adaptive learning process so as to continuously improve performance of the system.

### (Supplementary 3)

The system according to supplementary 1,
wherein the processor is configured to
cause the terminal device, during a training period in which the user intends predetermined actions, to transmit to the server the digital signals acquired in the training period in association with at least one of safety stop operation information, motion success or failure information, and evaluation information from the user obtained from the terminal device or a body-worn mechanism, and cause the server to update at least one of a classification threshold and an output class configuration of the intention information based on the association, and to adjust processing parameters of classification in the trained information processing model so as to reduce a probability of an erroneous operation.

### Application Example 1

### (Supplementary 1)

A system comprising a processor,
wherein the processor is configured to acquire biological signal time-series data representing brain activity of a subject by using a biological signal acquisition apparatus including a plurality of electrodes attached to a body surface of the subject,
segment the biological signal time-series data into time windows in a terminal apparatus, perform noise reduction processing and normalization processing on each time window, and transmit the processed time windows to the processor via a communication path,
receive, in the processor, the processed time windows from the terminal apparatus, perform data verification and buffering on the processed time windows, and convert the processed time windows into feature data acceptable as input to a machine learning model,
execute inference processing on the feature data by using a hierarchical learning model to select and identify an intended action of the subject from among a plurality of action classes,
generate motion command information including a type of assistance motion, joint trajectories, and output limitation values on the basis of the identified action class and subject-specific setting information, and transmit the motion command information to a motion assistance apparatus via the communication path,
control, in the motion assistance apparatus, a drive element on the basis of the motion command information while acquiring posture information and force information of a limb of the subject, so as to assist a body movement of at least one of a lower limb and an upper limb of the subject,
store, in a storage medium, the biological signal time-series data, the identified action class, the motion command information, and evaluation information from a user, and perform continuous relearning of the machine learning model on the basis of stored data so as to update intention estimation accuracy and suitability of the assistance motion, and
transmit, from the processor, a prompt sentence described in natural language to an external generative AI model, receive model configuration information or control algorithm information from the external generative AI model in response to the prompt sentence, and automatically design or improve at least one of the machine learning model and a control rule for the motion assistance apparatus on the basis of the received model configuration information or control algorithm information.

### (Supplementary 2)

The system according to supplementary 1,
wherein the processor is configured to implement the hierarchical learning model by using a convolutional layer configured to extract spatial and frequency features from the biological signal time-series data and a recurrent layer configured to analyze temporal patterns, and to execute inference processing by the convolutional layer and the recurrent layer while referring to an existing biological signal data set collected from multiple subjects.

### (Supplementary 3)

The system according to supplementary 1,
wherein the processor is configured to control the motion assistance apparatus so that the motion assistance apparatus detects position information and force information of the body of the subject, performs feedback control to reduce a tracking error with respect to the motion command information, and realizes a natural assistance motion corresponding to the intended action of the subject.

### Example 2

### (Supplementary 1)

A system comprising a processor,
wherein the processor is configured to
acquire brain-related signals and biological signals from a plurality of electrical signal measurement devices worn on a subject, the electrical signal measurement devices including electrodes configured to detect brain activity and sensors configured to detect biological activity,
analyze the acquired brain-related signals using a first learning model to perform an estimation process for estimating an intended action of the subject,
analyze the acquired brain-related signals and the acquired biological signals using a second learning model to perform an emotion estimation process for estimating an emotional state of the subject,
determine motion parameters of a motion support mechanical element worn on a body part of the subject based on the estimated intended action and the estimated emotional state, and control the motion support mechanical element based on the determined motion parameters,
store record information including the brain-related signals, the biological signals, the estimated intended action, the estimated emotional state, and the motion parameters, and update at least one of the first learning model and the second learning model based on the stored record information,
generate a natural language input sentence based on at least one of the record information and information relating to a control process or a learning process, transmit the natural language input sentence as a prompt sentence to a generative AI model, obtain an improvement proposal relating to at least one of a control logic and a learning algorithm from the generative AI model, and update at least one of the control process and the learning process based on the improvement proposal,
and transmit and receive data among the electrical signal measurement devices, the first learning model, the second learning model, the control process, the learning process, and the generative AI model.

### (Supplementary 2)

The system according to supplementary 1,
wherein the processor is configured to
use, as the first learning model, a multilayer neural network that performs convolution processing and time-series recurrent processing on the brain-related signals to output an action class and a probability distribution corresponding to the intended action of the subject,
use, as the second learning model, a multimodal neural network that receives features extracted from the brain-related signals and the biological signals and outputs emotion state scores including at least one of an anxiety level, a tension level, and a fatigue level,
and calculate the motion parameters including at least a motion speed coefficient and an assist torque coefficient based on the action class and the emotion state scores in order to adjust motion of the motion support mechanical element.

### (Supplementary 3)

The system according to supplementary 1,
wherein the processor is configured to
generate the prompt sentence including at least one of statistical values derived from the record information, the intended action, the emotional state, and a user evaluation index, transmit the prompt sentence to the generative AI model, obtain from the generative AI model a configuration proposal including at least one of a setting range of the motion parameters, a design of a state space, a design of an action space, and a design of a reward function for a control policy or a reinforcement learning algorithm,
and change at least one of parameter determination rules in the control process and model update processing in the learning process according to the configuration proposal.

### Application Example 2

### (Supplementary 1)

A system comprising a processor,
wherein the processor is configured to
acquire brain signal data, biological signal data, image data, and acoustic data of a subject from a plurality of sensing units, and perform preprocessing on the acquired data to generate time-aligned multimodal data including the brain signal data, the biological signal data, the image data, and the acoustic data, and to transmit the multimodal data from a terminal device to an information processing apparatus,
estimate an action intention of the subject based on the multimodal data by executing an action intention estimation process using a learned model that receives multidimensional signal features as input and outputs an action intention class,
estimate an emotional state of the subject based on the multimodal data by executing an emotional state estimation process using a learned model that receives physiological features, expression features, and voice features as input and outputs an emotional state class and an emotional intensity,
determine assist parameters including an assist level, a motion pattern, and a motion speed based on the action intention, the emotional state, and history information of the subject by executing an emotional engine process,
generate control commands for at least one of a wearable drive mechanism and a mobile drive mechanism based on the assist parameters, and control a robot apparatus configured to assist a body movement of the subject according to the control commands,
transmit, to a generative AI model, a prompt sentence written in natural language and including information relating to at least one of the action intention estimation process, the emotional state estimation process, an assist control process, and a guidance information generation process, acquire, from the generative AI model, output information including at least one of a text, a control algorithm proposal, and guidance information, and design or update at least a part of a structure or a parameter of at least one of the action intention estimation process, the emotional state estimation process, the emotional engine process, and a guidance presentation logic based on the output information,
acquire, from the generative AI model, guidance information corresponding to the action intention, the emotional state, and the assist parameters, and present the guidance information to the subject as at least one of voice information and display information via the terminal device, and
record history information including the action intention, the emotional state, the assist parameters, and a movement result, and update parameters of learned models used in the action intention estimation process, the emotional state estimation process, and the emotional engine process based on the history information.

### (Supplementary 2)

The system according to supplementary 1,
wherein the processor is configured to
execute the action intention estimation process and the emotional state estimation process by using deep learning models that receive the multimodal data as input, the action intention estimation process including a convolution operation layer and a time-series operation layer configured to output the action intention class of the subject, and the emotional state estimation process including an integration layer with an attention mechanism configured to integrate the physiological features, the expression features, and the voice features and to output the emotional state class and the emotional intensity.

### (Supplementary 3)

The system according to supplementary 1,
wherein the processor is configured to
execute the emotional engine process by using a rule-based inference unit configured to determine safety-oriented initial assist parameters based on the action intention and the emotional state, and a reinforcement learning model configured to individually optimize the assist parameters based on the initial assist parameters and the history information, and to control, by the robot apparatus, at least one of an output level and the motion speed in a feedback control manner according to the assist parameters.

What is claimed is:

1. A system comprising:
circuitry configured to:
receive, via a communication interface operating over a packet-switched network, time-series data sets from a terminal device, the time-series data sets representing preprocessed digital signals acquired from a plurality of sensing elements;
convert the time-series data sets into tensor data and execute inference processing using a trained information processing model that comprises a convolution computation layer configured to extract spatial and frequency features and a recurrent computation layer configured to analyze temporal transitions of the features, so as to output intention information corresponding to a predetermined action of a user;
generate high-level command data comprising at least an action type, a target parameter, and an intensity value based on the intention information, and transmit the high-level command data to the terminal device via the packet-switched network;
record, in a storage medium, the time-series data sets, the intention information, the high-level command data, and execution result information received from the terminal device in association with one another; and
perform adaptive learning processing to update parameters of the trained information processing model on a per-user basis using the recorded information.

2. The system according to claim 1, wherein the time-series data sets represent bioelectrical signals acquired via a plurality of electrodes attached to a body surface of the user, sampled at a predetermined sampling frequency and converted into digital signals.

3. The system according to claim 1, wherein the preprocessing of the digital signals comprises a band-pass filter process that passes only frequency components within a predetermined frequency band and a notch filter process that suppresses power-supply frequency components.

4. The system according to claim 1, wherein the terminal device is configured to segment continuous digital signals into signal intervals of a predetermined time length, normalize each signal interval by computing a moving mean and a moving standard deviation per channel and transforming sample values to standardized values, and encapsulate each normalized signal interval with metadata comprising a time stamp, a user identifier, and channel identifiers into a structured data segment.

5. The system according to claim 1, wherein the circuitry is further configured to convert the time-series data sets into the tensor data by arranging the time-series data sets into a multi-dimensional numerical array structure having dimensions corresponding to signal channels and temporal indices, and stacking a plurality of consecutive data sets to form a three-dimensional tensor.

6. The system according to claim 1, wherein the convolution computation layer is configured with kernel sizes that span a plurality of signal channels and a temporal window, and applies an activation function and a batch normalization operation after the convolution operation.

7. The system according to claim 1, wherein the recurrent computation layer comprises a long short-term memory network or a gated recurrent unit configured with a hidden state dimension sufficient to capture temporal dependencies across a plurality of seconds of the time-series data sets.

8. The system according to claim 1, wherein the circuitry is further configured to apply a fully connected output layer and a softmax function to output of the recurrent computation layer to compute probabilities for each of a plurality of predefined intention classes, and to select an intention class having a highest probability as the intention information subject to a confidence threshold.

9. The system according to claim 8, wherein the circuitry is further configured to compute a rejection class when all intention probabilities fall below the confidence threshold, and to suppress generation of the high-level command data in response to the rejection class.

10. The system according to claim 1, wherein the high-level command data further comprises a time stamp and a configuration flag specifying at least one of a maximum allowable output value and a maximum operational range.

11. The system according to claim 1, wherein the circuitry is further configured to transmit the high-level command data to the terminal device using a persistent messaging connection or a streaming protocol to reduce transmission latency.

12. The system according to claim 1, wherein the terminal device is configured to convert the high-level command data into low-level control data by transforming the action type and the intensity value into a sequence of target state values and allowable output ranges using a mapping table or a parameterized function stored in a memory of the terminal device.

13. The system according to claim 1, wherein the execution result information indicates at least one of a successful completion, an interruption, and an error condition associated with an operation performed based on the high-level command data.

14. The system according to claim 1, wherein the adaptive learning processing comprises computing a loss function measuring a discrepancy between predicted intention probabilities and reference labels derived from the execution result information, computing gradients of the loss function with respect to model weights using backpropagation, and updating the model weights using an adaptive gradient-based optimization algorithm with learning rate scheduling.

15. The system according to claim 1, wherein the circuitry is further configured to apply data augmentation to the recorded time-series data sets by adding noise perturbations or applying time-warping transformations prior to using the recorded time-series data sets for the adaptive learning processing.

16. The system according to claim 1, wherein the circuitry is further configured to execute a generative design process in which a generative artificial intelligence model receives at least one prompt sentence describing a structure of the trained information processing model, signal-processing conditions, a format of the high-level command data, and a control rule, and automatically generates or refines at least a part of the trained information processing model based on the prompt sentence.

17. The system according to claim 16, wherein the circuitry is further configured to parse a textual description received from the generative artificial intelligence model, convert the textual description into configuration parameters for the trained information processing model, evaluate the configuration parameters against performance metrics on a validation data set, and deploy updated configuration parameters when predefined improvement criteria are satisfied.

18. A system comprising:
circuitry configured to:
receive, via a communication interface operating over a packet-switched network using a transport layer security protocol, time-series data sets from a terminal device, the time-series data sets representing preprocessed digital bioelectrical signals acquired via a plurality of electrodes attached to a body surface of a user and sampled at a predetermined sampling frequency, each time-series data set corresponding to a signal interval of a predetermined time length and comprising a two-dimensional array of normalized sample values indexed by signal channels and temporal indices together with metadata including a time stamp and a user identifier;
store the time-series data sets in a storage medium indexed by the user identifier and the time stamp, and convert the time-series data sets into tensor data by arranging the two-dimensional arrays into a multi-dimensional numerical array structure and stacking a plurality of consecutive data sets to form a three-dimensional tensor having axes corresponding to signal channels, time, and a data set index;
execute inference processing by inputting the tensor data to a trained information processing model comprising a convolution computation layer configured to extract spatial and frequency features by applying learnable filters having kernel sizes spanning a plurality of signal channels and a temporal window with an activation function and a batch normalization operation, a pooling operation to reduce temporal resolution, and a recurrent computation layer comprising a long short-term memory network configured to update a hidden state at each time step based on pooled feature vectors, and a fully connected output layer with a softmax function to compute probabilities for each of a plurality of predefined intention classes;
select an intention class having a highest probability as intention information subject to a confidence threshold, and generate high-level command data comprising at least an action type, a target parameter, an intensity value, a time stamp, and a configuration flag specifying a maximum allowable output value based on the intention information;
transmit the high-level command data to the terminal device via the packet-switched network using a persistent messaging connection;
record, in the storage medium, the time-series data sets, the intention information, the high-level command data, and execution result information received from the terminal device in association with one another, the execution result information indicating at least one of a successful completion, an interruption, and an error condition;
perform adaptive learning processing comprising partitioning the recorded information into training and validation data sets, computing a loss function measuring a discrepancy between predicted intention probabilities and reference labels, computing gradients using backpropagation, and updating parameters of the trained information processing model using an adaptive gradient-based optimization algorithm; and
execute a generative design process in which a generative artificial intelligence model receives at least one prompt sentence describing a structure of the trained information processing model, signal-processing conditions, and a format of the high-level command data, and automatically generates or refines at least a part of the trained information processing model based on the prompt sentence.

19. The system according to claim 18, wherein the terminal device is configured to receive the high-level command data, convert the high-level command data into low-level control data comprising target state values and allowable output ranges for a multi-joint drive mechanism using a mapping table stored in a memory of the terminal device, and transmit the low-level control data to the multi-joint drive mechanism via a local communication path, and wherein the multi-joint drive mechanism executes feedback control computation at a predetermined cycle to correct a drive output in accordance with a difference between a detection value from a sensor and a target trajectory derived from the low-level control data.

20. A method performed by circuitry of a system, the method comprising:
receiving, via a communication interface operating over a packet-switched network, time-series data sets from a terminal device, the time-series data sets representing preprocessed digital signals acquired from a plurality of sensing elements;
converting the time-series data sets into tensor data and executing inference processing using a trained information processing model that comprises a convolution computation layer configured to extract spatial and frequency features and a recurrent computation layer configured to analyze temporal transitions of the features, so as to output intention information corresponding to a predetermined action of a user;
generating high-level command data comprising at least an action type, a target parameter, and an intensity value based on the intention information, and transmitting the high-level command data to the terminal device via the packet-switched network;
recording, in a storage medium, the time-series data sets, the intention information, the high-level command data, and execution result information received from the terminal device in association with one another; and
performing adaptive learning processing to update parameters of the trained information processing model on a per-user basis using the recorded information.
